(19) United States
(12) Patent Application Publication
(10) Pub. No.: US 2013/0314497 A1
(43) Pub. Date: Nov. 28, 2013

(54) SIGNAL PROCESSING APPARATUS, SIGNAL PROCESSING METHOD AND PROGRAM

(71) Applicant: Sony Corporation, Tokyo (JP)

(72) Inventor: Yuji Tsuchida, Kanagawa (JP)

(73) Assignee: Sony Corporation, Tokyo (JP)

(21) Appl. No.: 13/895,437

(22) Filed: May 16, 2013

(30) Foreign Application Priority Data
May 23, 2012 (JP) 2012-117091

(51) Int. Cl. H04N 13/00

(52) U.S. Cl. CPC H04N 13/00
USPC 348/43

(57) ABSTRACT

There is provided a signal processing apparatus including a disparity mode value calculating unit calculating a mode value of disparity related to dynamic image information, a time interval extracting unit extracting a time interval suitable for cooperation of perception of an anteroposterior sense from a change in a time direction of the mode value calculated by the disparity mode value calculating unit, and a control signal generating unit generating a sound control signal to control a depth sense of sound information related to the dynamic image information in the time interval extracted by the time interval extracting unit.

### BACKGROUND

The present disclosure relates to a signal processing apparatus, signal processing method and program. Specifically, the present disclosure relates to a signal processing apparatus, signal processing method and program that can cause the image depth feel and the sound depth feel to work together.

In the filming of live-action movies or drams, to improve the articulation score in lines or enable sounds to be dubbed into many languages, the following is performed. That is, at the time of recording lines, microphones are arranged near performers instead of a lens of a camera used for filming and only lines are selectively recorded.

Also, especially in the case of shooting on location, to avoid a surrounding environment sound and an influence of wind blown to microphones, only lines are often post-recorded in a studio.

In the case of adopting such a control method, there are many cases where an image distance sense and a line distance sense are not matched in principle. Also, in animation products, since an image creation and a line recording are separately performed in the first place, there are many cases where the image distance sense and the line distance sense are not matched.

In an image product created through the above-mentioned creation process, although there is less feeling of strangeness in 2D products in the related art, since the depth expression of images is added in the case of 3D products, the image distance sense and the sound distance sense are not matched in an emphasized manner and the realistic sensation of 3D image experience is impaired.

By contrast with this, it is suggested to control a sound field using 3D image depth information and cause the image depth expression and the sound depth expression to work together (see Japanese Patent Laid-Open No. 2011-216963). In this suggestion, the image depth information is acquired by finding the image depth information from a 3D image by a method such as stereo matching or extracting the depth information added to the image, and, based on the acquired information, a sound control signal is generated to control sound.

### SUMMARY

However, as disclosed in Japanese Patent Laid-Open No. 2011-216963, in the case of performing processing of generating sound control information from image depth information and causing the image depth sense and the sound depth sense to work together, for example, in a case where a depth structure varies by scene changes or depth information is acquired by stereo matching in a scene of low contrast or the like, it may not reliably say that the control result causes a good effect.

The present disclosure is made in view of such a situation and can effectively cause the image depth sense and the sound depth sense to work together.

According to an embodiment of the present disclosure, there is provided a signal processing apparatus including a disparity mode value calculating unit calculating a mode value of disparity related to dynamic image information, a time interval extracting unit extracting a time interval suitable for cooperation of perception of an anteroposterior sense from a change in a time direction of the mode value calculated by the disparity mode value calculating unit, and a control signal generating unit generating a sound control signal to control a depth sense of sound information related to the dynamic image information in the time interval extracted by the time interval extracting unit.

The time interval extracting unit may detect a change in a scene structure of the dynamic image information based on the dynamic image information and the mode value calculated by the disparity mode value calculating unit, and removes a time interval in which the change is detected.

The scene structure change detecting unit may include a time differentiation unit performing time differentiation on the mode value calculated by the disparity mode value calculating unit, and a non-linear conversion unit performing non-linear conversion on the mode value subjected to time differentiation in the time differentiation unit. And the control signal generating unit may include a time integration unit performing time integration on the mode value subjected to non-linear conversion in the non-linear conversion unit.

The scene structure change detecting unit may further include an initialization deciding unit initializing the time integration performed by the time integration unit, according to magnitude of an absolute value of the mode value calculated by the disparity mode value calculating unit.

The time interval extracting unit may include a mode value reliability deciding unit evaluating a reliability of the mode value based on the dynamic image information and the mode value calculated by the disparity mode value calculating unit and removing a time interval in which the reliability of the mode value is low.

The mode value reliability deciding unit may include a time differentiation unit performing time differentiation on the mode value calculated by the disparity mode value calculating unit, and a non-linear conversion unit performing non-linear conversion on the mode value subjected to time differentiation in the time differentiation unit. And the control signal generating unit may include a time integration unit performing time integration on the mode value subjected to non-linear conversion in the non-linear conversion unit.

The signal processing apparatus may further include a disparity maximum value calculating unit calculating a maximum value of the disparity, and a disparity minimum value calculating unit calculating a minimum value of the disparity. The mode value reliability deciding unit may further include an initialization deciding unit initializing the time integration performed by the time integration unit, according to at least one of magnitude of a difference between the maximum value calculated by the disparity maximum value calculating unit and the minimum value calculated by the disparity minimum value calculating unit, a time change in the maximum value and a time change in the minimum value.

The initialization deciding unit may initialize the time integration performed by the time integration unit, according to the magnitude of an absolute value of the mode value calculated by the disparity mode value calculating unit.

The time interval extracting unit may include a sound control effect evaluating unit evaluating, based on sound information related to the dynamic image information and the mode value calculated by the disparity mode value calculating unit, an effect in a case where the sound information is controlled by the dynamic image information, and changing the sound control signal.

The sound control effect evaluating unit may include a time differentiation unit performing time differentiation on the mode value calculated by the disparity mode value calculating unit, and a non-linear conversion unit performing non-linear conversion on the mode value subjected to time differentiation in the time differentiation unit. And the control signal generating unit may include a time integration unit performing time integration on the mode value subjected to non-linear conversion in the non-linear conversion unit.

The sound control effect evaluating unit may further include an initialization deciding unit initializing the time integration performed by the time integration unit, according to a difference between the mode value calculated by the disparity mode value calculating unit and a time average value of the mode value.

The initialization deciding unit may initialize the time integration performed by the time integration unit, according to magnitude of an absolute value of the mode value calculated by the disparity mode value calculating unit.

According to an embodiment of the present disclosure, there is provided a signal processing method in which a signal processing apparatus performs operations of calculating a mode value of disparity related to dynamic image information, extracting a time interval suitable for cooperation of perception of an anteroposterior sense from a change in a time direction of the calculated mode value, and generating a sound control signal to control a depth sense of sound information related to the dynamic image information in the extracted time interval.

According to an embodiment of the present disclosure, there is provided a program for causing a computer to function as a disparity mode value calculating unit calculating a mode value of disparity related to dynamic image information, a time interval extracting unit extracting a time interval suitable for cooperation of perception of an anteroposterior sense from a change in a time direction of the mode value calculated by the disparity mode value calculating unit, and a control signal generating unit generating a sound control signal to control a depth sense of sound information related to the dynamic image information in the time interval extracted by the time interval extracting unit.

According to another embodiment of the present disclosure, there is provided a signal processing apparatus including a disparity mode value calculating unit calculating a mode value of disparity related to dynamic image information, a time differentiation unit performing time differentiation on the mode value calculated by the disparity mode value calculating unit, a non-linear conversion unit performing non-linear conversion on the mode value subjected to time differentiation in the time differentiation unit, and a time integration unit performing time integration on the mode value subjected to non-linear conversion in the non-linear conversion unit.

In an embodiment of the present disclosure, a mode value of disparity related to dynamic image information is calculated. Further, a time interval suitable for cooperation of perception of an anteroposterior sense is extracted from a change in a time direction of the calculated mode value and a sound control signal to control a depth sense of sound information related to the dynamic image information in the extracted time interval is generated.

In another embodiment of the present disclosure, a mode value of disparity related to dynamic image information is calculated. Further, the calculated mode value is subjected to time differentiation, the mode value subjected to time differentiation is subjected to non-linear conversion and the mode value subjected to non-linear conversion is subjected to time integration.

According to the present disclosure, it is possible to cause the image depth sense and the sound depth sense to work together. Especially, it is possible to effectively cause the image depth sense and the sound depth sense to work together.

### BRIEF DESCRIPTION OF THE DRAWINGS

FIG. 1 is a block diagram illustrating a configuration example of a signal processing apparatus to which the present disclosure is applied;

FIG. 2 is a flowchart for explaining signal processing of a signal processing apparatus;

FIG. 3 is a block diagram illustrating a specific configuration example of a signal processing unit;

FIG. 4 is a view illustrating an example of frequency distribution of disparity;

FIG. 5 is a view illustrating an example of non-linear transfer characteristics;

FIG. 6 is a view illustrating a time change example of a mode value, maximum value and minimum value of disparity in a case where a scene change occurs;

FIG. 7 is a view illustrating an example of performing time differentiation on the mode value of disparity in FIG. 6;

FIG. 8 is a view illustrating an example of performing non-linear conversion on the mode value of disparity in FIG. 7;

FIG. 9 is a view illustrating an example of performing time integration on the mode value of disparity subjected to non-linear conversion in FIG. 8;

FIG. 10 is a view illustrating a frequency distribution example of disparity in a case where an image contrast is low;

FIG. 11 is a view illustrating a time change example of a mode value, maximum value and minimum value of disparity in FIG. 10;

FIG. 12 is a view illustrating an example of performing time differentiation on the mode value of disparity in FIG. 11;

FIG. 13 is a view illustrating an example of performing non-linear conversion on the mode value of disparity subjected to time differentiation in FIG. 12;

FIG. 14 is a view illustrating an example of performing time integration on the mode value of disparity subjected to non-linear conversion in FIG. 13;

FIG. 15 is a view illustrating a frequency distribution example of disparity in a case where the area ratios of two objects to the entire screen are substantially equal;

FIG. 16 is a view illustrating a time change example of a mode value, maximum value and minimum value of disparity in FIG. 15;

FIG. 17 is a view illustrating an example of performing time differentiation on the mode value of disparity in FIG. 16;

FIG. 18 is a view illustrating an example of performing non-linear conversion on the mode value of disparity subjected to time differentiation in FIG. 17;

FIG. 19 is a view illustrating an example of performing time integration on the mode value of disparity subjected to non-linear conversion in FIG. 18;

FIG. 20 is a view illustrating a time change example of a mode value, maximum value and minimum value of disparity in a scene in which the main subject moves from the far side to the near side;

FIG. 21 is a view illustrating an example of performing time differentiation on the mode value of disparity in FIG. 20;

FIG. 22 is a view illustrating an example of performing non-linear conversion on the mode value of disparity subjected to time differentiation in FIG. 21;

FIG. 23 is a view illustrating an example of performing time integration on the mode value of disparity subjected to non-linear conversion in FIG. 22;

FIG. 24 is a view illustrating another example of non-linear conversion characteristics;

FIG. 25 is a block diagram illustrating a specific configuration example of a sound controlling unit;

FIG. 26 is a view illustrating an example of frequency characteristics;

FIG. 27 is a view for explaining a sound pressure gain of direct sound;

FIG. 28 is a view illustrating a characteristic example of a sound pressure gain;

FIG. 29 is a view illustrating a characteristic example of delay time of primary reflection sound;

FIG. 30 is a view illustrating an example of a sound pressure ratio characteristic of primary reflection sound; and

FIG. 31 is a block diagram illustrating a configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the following, configurations to implement the present disclosure (hereinafter referred to as “embodiments”) are explained. Here, the explanation is performed in the following order.

1. First Embodiment (Signal Processing Apparatus)

2. Second Embodiment (Computer)

### 1. First Embodiment

### Outline of the Present Disclosure

As described above, in Japanese Patent Laid-Open No. 2011-216963, it is suggested to control a sound field using 3D image depth information and cause the image depth expression and the sound depth expression to work together. In this suggestion, the image depth information is acquired by finding the image depth information from a 3D image by a method such as stereo matching or extracting the depth information added to the image, and, based on the acquired information, a sound control signal is generated to control sound.

However, as disclosed in Japanese Patent Laid-Open No. 2011-216963, in the case of performing processing of generating sound control information from image depth information and causing the image depth sense and the sound depth sense to work together, in the following cases, it may not reliably say that the control result causes a good effect.

First, there is a case where a depth structure of the entire screen varies by scene changes. It is rare that an image creator creates a 3D image while paying attention to even the depth structure of each scene, and, in most cases, a depth information change by scene changes is not intended by the creator. Therefore, when sound control is performed using such a depth information change, there is a case where an unintended unnatural result is caused.

Second, there is a case where image depth information is acquired from a 3D image using stereo matching. Characteristics of the stereo matching include that, in a scene of low image contrast, it is difficult to find depth information accurately and a depth analysis result is uncertain or indicates an unstable behavior. Therefore, when sound control is performed using such depth information, there is a case where the sound control becomes unstable.

Third, there is a case where depth information is acquired with respect to a scene formed with main objects having multiple different items of depth information. For example, in a scene formed with two main objects of “character” and “background,” the depth distribution of the entire screen includes two large biases. At this time, which object is more significant is reasoned depending on information such as the ratio of an area to the entire screen, an anteroposterior relationship of depth and a brightness relationship of the objects. However, in a case where, using any method, it is difficult to reliably decide which object is more significant, there is a possibility that sound control is performed based on depth information of a wrong object.

Fourth, there is a case where the rapid time change of depth information is caused in an image. When sound is caused to work together with such rapid time change of depth information, there is a possibility that: sound control is not followed in time and an intended effect is not acquired; and, furthermore, a time lag is caused in order to follow it and unnaturalness is caused in the sound control.

Also, regarding these, in order to detect depth information accurately, when it is configured to refer to much depth information of future image frames, since the eventual sound control is accordingly delayed, the image is requested to be relatively delayed. In this case, many image delay memories are requested, which increases the cost.

Therefore, in the present disclosure, the mismatch between the image distance sense and the sound distance sense in a 3D product is suppressed by adjusting the sound depth sense using 3D image depth information. Further, in the present disclosure, at that time, by removing information unsuitable for cooperation between the above-mentioned image and sound, it is possible to acquire a good cooperation effect of the image and sound.

### [Configuration of Signal Processing Apparatus]

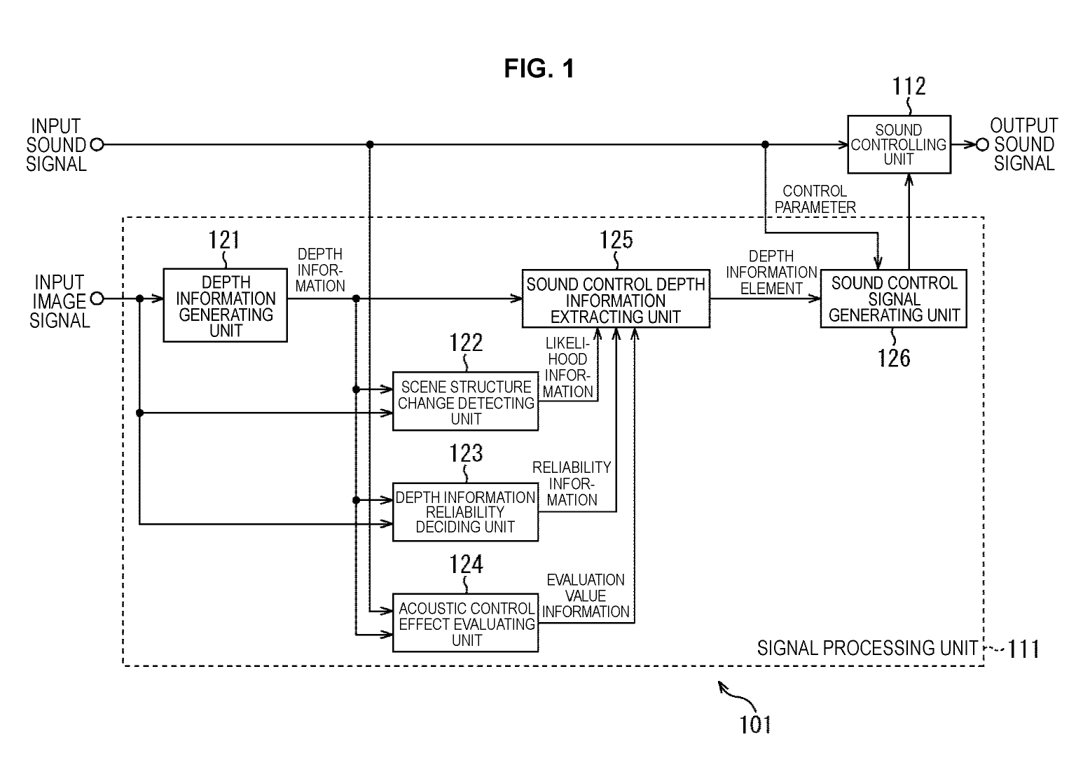

FIG. 1 is a block diagram illustrating a configuration example of a signal processing apparatus to which the present disclosure is applied.

For example, a signal processing apparatus 101 inputs an image signal of a 3D image and a sound signal supporting the image signal, generates a sound control signal using the input image signal, controls the input sound signal based on the generated sound control signal and outputs the controlled sound signal. By this means, it is possible to cause the image depth sense and the sound depth sense to work together. In the example of FIG. 1, the signal processing apparatus 101 is formed including a signal processing unit 111 and a sound controlling unit 112.

The signal processing unit 111 is formed including a depth information generating unit 121, a scene structure change detecting unit 122, a depth information reliability deciding unit 123, an acoustic control effect evaluating unit 124, a sound control depth information extracting unit 125 and a sound control signal generating unit 126.

An input image signal from the unillustrated previous stage is supplied to the depth information generating unit 121, the scene structure change detecting unit 122 and the depth information reliability deciding unit 123. An input sound signal from the previous stage is supplied to the acoustic control effect evaluating unit 124 and the sound control signal generating unit 126.

The depth information generating unit 121 generates depth information from the input image signal. The generation of the depth information is performed by extracting the depth information attached to the input image signal or performing stereo matching processing on right and left images. The depth information generating unit 121 supplies the generated depth information to the scene structure change detecting unit 122, the depth information reliability deciding unit 123, the acoustic control effect evaluating unit 124 and the sound control depth information extracting unit 125.

The scene structure change detecting unit 122 detects the magnitude of time change in the image signal and the magnitude of time change in the depth structure, from the input image signal and the depth information, and eventually generates scene change likelihood information. The scene structure change detecting unit 122 supplies the generated likelihood information to the sound control depth information extracting unit 125.

The depth information reliability deciding unit 123 generates the reliability of the depth information from the input image signal and the depth information. For example, the reliability of the depth information is found by evaluating a feature of the distribution profile of the depth information, a spatial frequency component included in the image signal or the contrast. The depth information reliability deciding unit 123 supplies the generated reliability information to the sound control depth information extracting unit 125.

The acoustic control effect evaluating unit 124 generates an evaluation value of an image sound cooperation effect acquired by using the depth information for acoustic control, from the input sound signal and the depth information. For example, preliminary (e.g. on the design stage), using a sound signal generated by directly inputting the depth information output from the depth information generating unit 121 in the sound control signal generating unit 126, a result at the time of performing sound control in the sound controlling unit 112 is evaluated. The evaluation value of the image sound cooperation result is output based on the preliminary-evaluated result. The acoustic control effect evaluating unit 124 supplies the generated evaluation value information of the image sound cooperation effect to the sound control depth information extracting unit 125.

The sound control depth information extracting unit 125 extracts a time-space depth information element suitable for sound control from the depth information from the depth information generating unit 121, based on the supplied scene change likelihood information, the supplied reliability information of the depth information and the supplied evaluation value information of the image sound cooperation effect. The sound control depth information extracting unit 125 supplies the extracted time-space depth element information to the sound control signal generating unit 126. That is, the sound control depth information extracting unit 125 deletes a time-space depth information element that is not suitable for sound control.

The sound control signal generating unit 126 generates a control parameter, which is suitable for a control method in the sound controlling unit 112 and the input sound signal from the previous stage, based on the time-space depth information element from the sound control depth information extracting unit 125. The sound control signal generating unit 126 supplies the generated control parameter to the sound controlling unit 112.

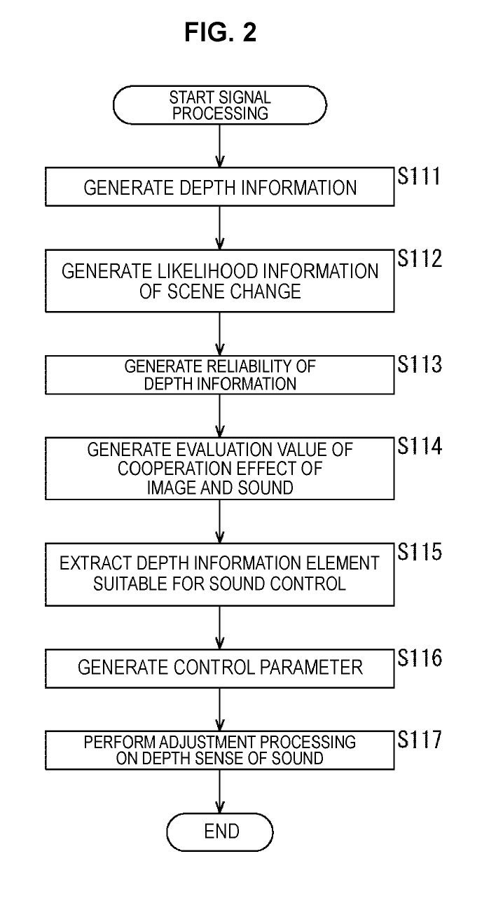

Here, as the depth information, the disparity is used after FIG. 2. That is, the sound control depth information extracting unit 125 extracts a time interval suitable for cooperation of perception (i.e. visual sense and auditory sense) of the anteroposterior sense, from a change in the time direction of the mode value of disparity found by the depth information from the depth information generating unit 121. Subsequently, the sound control signal generating unit 126 generates a sound control signal to control the depth sense of sound information related to dynamic image information in the time interval extracted by the sound control depth information extracting unit 125.

Based on the control parameter from the sound control signal generating unit 126, the sound controlling unit 112 performs adjustment processing of the sound depth sense cooperating with an image signal, with respect to the input sound signal on the previous stage, and generates an output sound signal subjected to adjustment processing. The sound controlling unit 112 outputs the generated output sound signal to an unillustrated subsequent stage.

### [Operation of Signal Processing Apparatus]

Next, with reference to the flowchart in FIG. 2, signal processing in the signal processing apparatus 101 is explained.

The input image signal from the previous stage is supplied to the depth information generating unit 121, the scene structure change detecting unit 122 and the depth information reliability deciding unit 123. The input sound signal from the previous stage is supplied to the acoustic control effect evaluating unit 124 and the sound control signal generating unit 126.

In step S111, the depth information generating unit 121 generates depth information from the input image signal from the previous stage. The depth information generating unit 121 supplies the generated depth information to the scene structure change detecting unit 122, the depth information reliability deciding unit 123, the acoustic control effect evaluating unit 124 and the sound control depth information extracting unit 125.

In step S112, the scene structure change detecting unit 122 detects the magnitude of time change in the image signal and the magnitude of time change in the depth structure, from the input image signal from the previous stage and the depth information from the depth information generating unit 121, and eventually generates scene change likelihood information. The scene structure change detecting unit 122 supplies the generated likelihood information to the sound control depth information extracting unit 125.

In step S113, the depth information reliability deciding unit 123 generates the reliability of the depth information from the input image signal from the previous stage and the depth information from the depth information generating unit 121. The depth information reliability deciding unit 123 supplies the generated reliability information to the sound control depth information extracting unit 125.

In step S114, the acoustic control effect evaluating unit 124 generates an evaluation value of an image sound cooperation effect acquired by using the depth information for acoustic control, from the input sound signal from the previous stage and the depth information from the depth information generating unit 121. The acoustic control effect evaluating unit 124 supplies information of the generated evaluation value of the image sound cooperation effect to the sound control depth information extracting unit 125.

In step S115, the sound control depth information extracting unit 125 extracts a time-space depth information element suitable for sound control from the depth information from the depth information generating unit 121. This extraction processing is performed based on the scene change likelihood information from the scene structure change detecting unit 122, the reliability information of the depth information from the depth information reliability deciding unit 123 and the evaluation value information of the image sound cooperation effect from the acoustic control effect evaluating unit 124. That is, a time-space depth information element that is not suitable for sound control is deleted in the sound control depth information extracting unit 125. The sound control depth information extracting unit 125 supplies the extracted time-space depth element information to the sound control signal generating unit 126.

In step S116, the sound control signal generating unit 126 generates a control parameter, which is suitable for a control method in the sound controlling unit 112 and the input sound signal from the previous stage, based on the time-space depth information element from the sound control depth information extracting unit 125. The sound control signal generating unit 126 supplies the generated control parameter to the sound controlling unit 112.

In step S117, based on the control parameter from the sound control signal generating unit 126, the sound controlling unit 112 performs adjustment processing of the sound depth sense cooperating with an image signal, with respect to the input sound signal on the previous stage, and generates an output sound signal subjected to adjustment processing. The sound controlling unit 112 outputs the generated output sound signal to an unillustrated subsequent stage.

As described above, in the signal processing apparatus 101, a time-space depth information element that is not suitable for sound control is deleted based on the scene change likelihood information, the reliability information of the depth information and the evaluation value information of the image sound cooperation effect or the like. Therefore, since the sound control is performed only on the time-space depth information element suitable for the sound control, the mismatch between the image distance sense and the sound distance sense in a 3D product can be suppressed by adjusting the sound depth sense using 3D image depth information.

### [Specific Configuration Example of Signal Processing Unit]

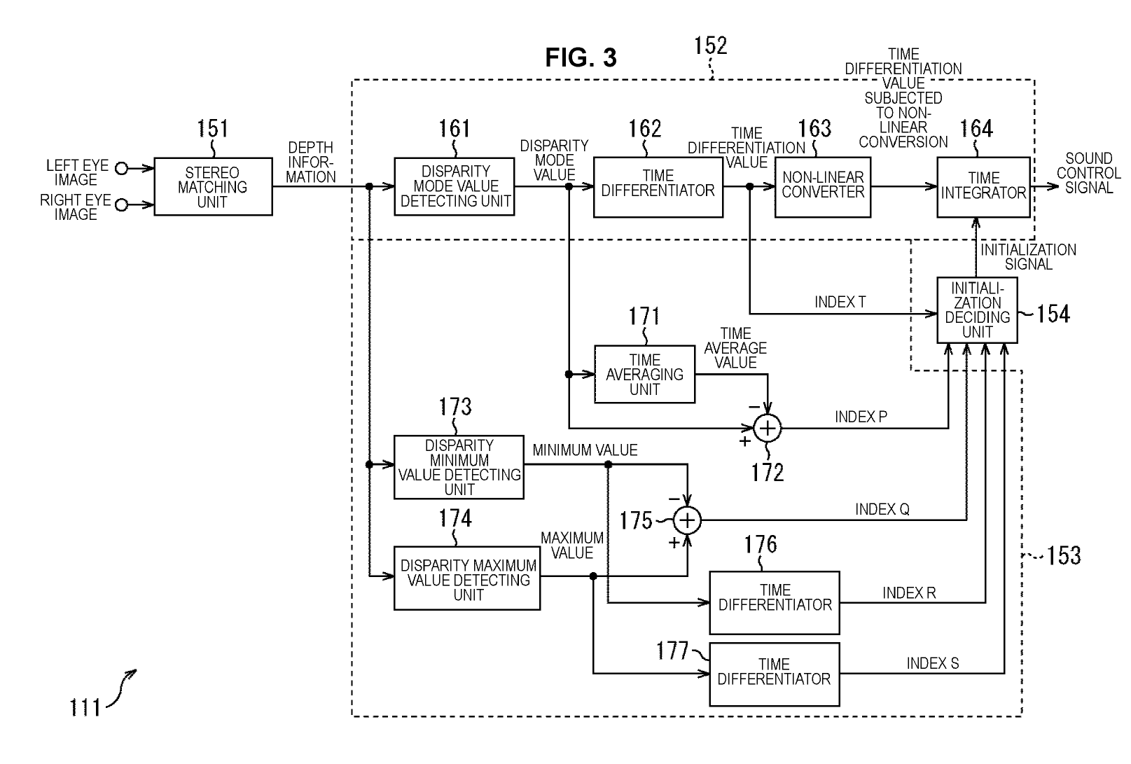

Next, with reference to FIG. 3, a specific configuration example to realize the signal processing unit 111 in FIG. 1 is explained. FIG. 3 is a block diagram illustrating an embodiment of the signal processing unit 111. Also, after FIG. 3, using the horizontal distance between pixels corresponding to the left eye image and the right eye image as depth information, this is referred to as “disparity” and explained.

For example, the signal processing unit 111 is formed including a stereo matching unit 151, a mode value generation processing unit 152, an index calculation processing unit 153 and an initialization deciding unit 154.

The stereo matching unit 151 finds depth information and outputs the found depth information to the mode value generation processing unit 152 and the index calculation processing unit 153.

The mode value generation processing unit 152 finds the mode value of disparity from the depth information from the stereo matching unit 151, performs derivation, non-linear conversion and integration according to an initialization signal from the initialization deciding unit 154, and eventually outputs the result as a sound control signal to the sound controlling unit 112.

The mode value generation processing unit 152 is formed including a disparity mode value detecting unit 161, a time differentiator 162, a non-linear converter 163 and a time integrator 164.

The disparity mode value detecting unit 161 detects a disparity mode value of the highest frequency in the depth information from the stereo matching unit 151 and outputs the detected disparity mode value to the time differentiator 162. This disparity mode value is also output to a time averaging unit 171 and a subtracting unit 172 in the index calculation processing unit 153.

In image contents, since there are many cases where an object covering the largest area in a screen is a main sound source of the sound center channel, it is possible to consider that depth position information of the sound source of the center channel is included in the disparity mode value.

The time differentiator 162 performs time differentiation on the disparity mode value from the disparity mode value detecting unit 161, finds a time differentiation value of the disparity mode value and outputs the found time differentiation value of the disparity mode value to the non-linear converter 163. This time differentiation value of the disparity mode value is also supplied to the initialization deciding unit 154 as an index T which is one of indices described below.

The non-linear converter 163 performs non-linear conversion on the time differentiation value of the disparity mode value from the time differentiator 162 and outputs the time differentiation value of disparity mode value subjected to non-linear conversion to the time integrator 164.

The time integrator 164 performs time integration on the time differentiation value of disparity mode value subjected to non-linear conversion from the non-linear converter 163, in an integrator initialized by the initialization signal from the initialization deciding unit 154, thereby outputting an optimized disparity mode value to the sound controlling unit 112 as a sound control signal.

Using the depth information from the stereo matching unit 151 and the disparity mode value from the disparity mode value detecting unit 161, the index calculation processing unit 153 performs processing of calculating an index to generate the initialization signal for the time integrator 164, and outputs the calculated index to the initialization deciding unit 154.

The index calculation processing unit 153 is formed including the time averaging unit 171, the subtracting unit 172, a disparity minimum value detecting unit 173, a disparity maximum value detecting unit 174, a subtracting unit 175, a time differentiator 176 and a time differentiator 177.

The time averaging unit 171 performs a time average of the disparity mode value from the disparity mode value detecting unit 161 and outputs the time average value of the mode value to the subtracting unit 172. The subtracting unit 172 outputs a value subtracting the time average value of the mode value from the disparity mode value from the disparity mode value detecting unit 161, to the initialization deciding unit 154 as an index P.

The disparity minimum value detecting unit 173 detects the disparity minimum value from the depth information from the stereo matching unit 151 and outputs the detected disparity minimum value to the subtracting unit 175 and the time differentiator 176. The disparity maximum value detecting unit 174 detects the disparity maximum value from the depth information from the stereo matching unit 151 and outputs the detected disparity maximum value to the subtracting unit 175 and the time differentiator 177.

The subtracting unit 175 outputs a difference between the disparity minimum value from the disparity minimum value detecting unit 173 and the disparity maximum value from the disparity maximum value detecting unit 174, to the initialization deciding unit 154 as an index Q.

The time differentiator 176 performs time differentiation on the disparity minimum value from the disparity minimum value detecting unit 173 and outputs the time differentiation value of the minimum value to the initialization deciding unit 154 as an index R. The time differentiator 177 performs time differentiation on the disparity maximum value from the disparity maximum value detecting unit 174 and outputs the time differentiation value of the maximum value to the initialization deciding unit 154 as an index S.

The initialization deciding unit 154 outputs, to the time integrator 164, an initialization signal to initialize the time integrator 164 based on at least one of multiple indices from the index calculation processing unit 153.

### [Example of Depth Information]

The stereo matching unit 151 finds the disparity per pixel or block corresponding to multiple pixels, from the left eye image and the right eye image input from the previous stage.

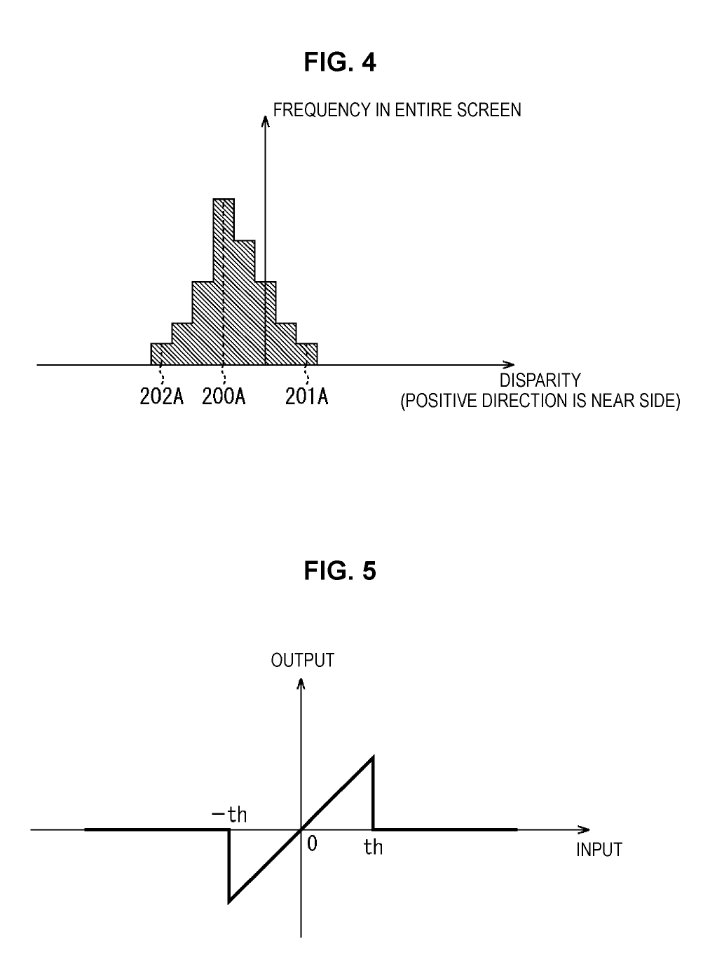

Here, various schemes are suggested for stereo matching processing, and, because of differences between these schemes, there are differences in found disparity granularities or the meanings of values corresponding to disparity appearance frequency. However, in the stereo matching unit 151 according to the present embodiment, eventually, as illustrated in FIG. 4, results consolidated into the disparity frequency distribution in the entire screen are output as depth information.

In the example of FIG. 4, a disparity mode value 200A, a disparity maximum value 201A and a disparity minimum value 202A are illustrated in the frequency distribution in which the horizontal axis indicates disparity (the positive direction is the near side) and the vertical axis indicates frequency in the entire screen.

Also, as described below, after the stereo matching unit 151, among the results consolidated into the frequency distribution, only these disparity mode value 200A, disparity maximum value 201A and disparity minimum value 202A are used and frequency information is not used. Therefore, a frequency value may not have linearity with respect to an area ratio in the entire screen, that is, since only the mode value, the maximum value and the minimum value are used and information on the vertical axis is not used, at least monotonicity may be requested.

Also, a target range of disparity frequency distribution may not be the entire screen, and, for example, it may be limited to a main part of the central part of the screen.

By employing such a configuration, in the present embodiment, it is less dependent on a stereo matching scheme.

### [Specific Example of Non-Linear Conversion]

Next, an object of non-linear conversion in the non-linear converter 163 is explained in detail. In the non-linear converter 163, for example, as illustrated in FIG. 5, a non-liner conversion characteristic is used in which, when the absolute value of an input is larger than a certain threshold th, its output is set to 0.

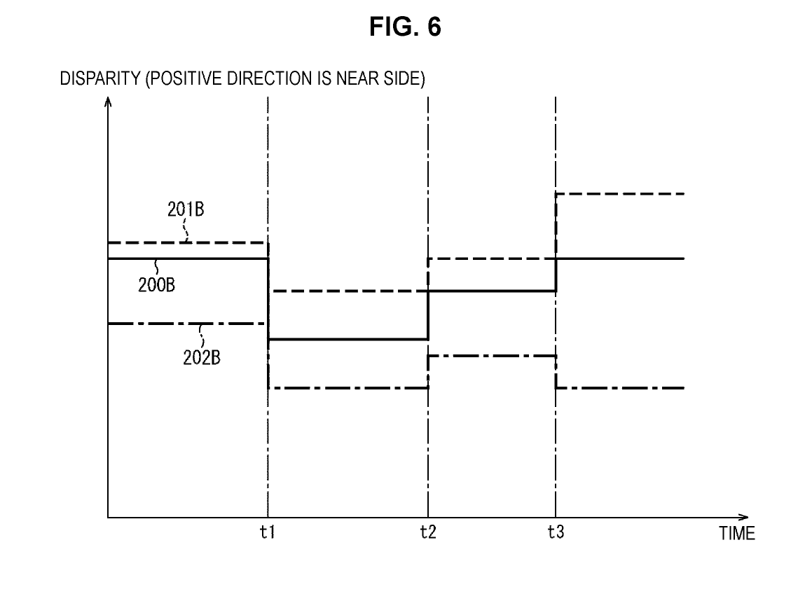

FIG. 6 is a view illustrating a time change example of a disparity mode value 200B, the disparity maximum value 201B and the disparity minimum value 202B in a case where a scene change occurs, as the first example. The vertical axis indicates disparity (the positive direction is the near side) and the horizontal axis indicates the time.

In the example of FIG. 6, a scene change occurs at time t1, time t2 and time t3, and, every time, the depth structure of the entire screen changes. Thus, in a case where the depth structure changes by a scene change, discontinuous changes occur in the disparity mode value 200B.

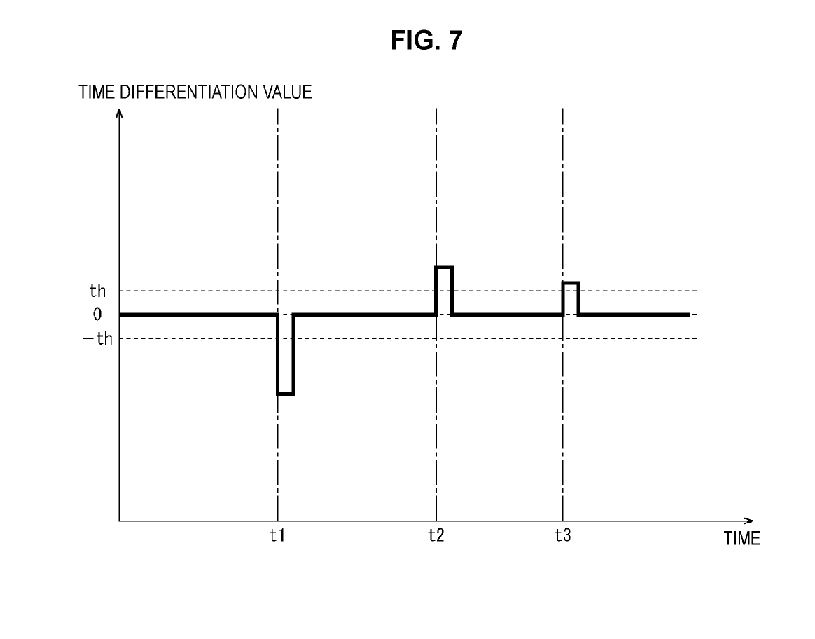

When this disparity mode value 200B is subjected to time differentiation in the time differentiator 162, a signal as illustrated in FIG. 7 is acquired. The vertical axis indicates a time differentiation value and the horizontal axis indicates the time.

In the example of FIG. 7, every scene change, the absolute value of a disparity time differentiation value, which is equal to or above th, is caused.

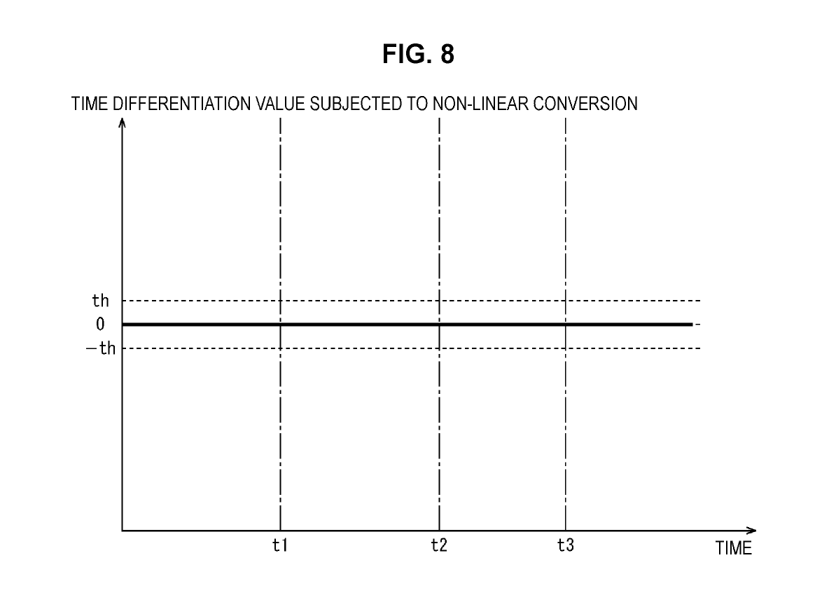

Generally, in a case where a scene change occurs, for example, as illustrated in FIG. 7, there are many cases where the absolute value of the disparity time differentiation value is much greater than the adequately-set threshold th. Therefore, in the non-linear converter 163, by performing non-linear conversion on the characteristic illustrated in above FIG. 5, as illustrated in FIG. 8, it is possible to substantially remove a scene change influence from the time differentiation value of the disparity mode value.

In the example of FIG. 8, the vertical axis indicates a time differentiation value subjected to non-linear conversion and the horizontal axis indicates the time, where the time differentiation value subjected to non-linear conversion indicates 0 at any time.

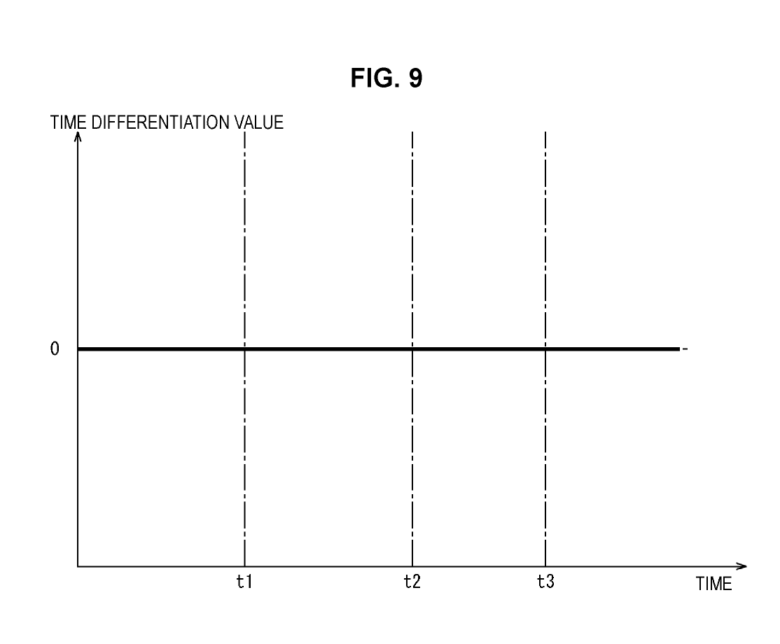

Also, by performing time integration on this time differentiation value of disparity mode value subjected to non-linear conversion in the time integrator 164, as illustrated in FIG. 9, it is possible to acquire a disparity mode value from which a scene change influence is substantially removed. That is, there are many cases where a scene change is not an intentional depth change, and, by removing it since it is not suitable for sound control, it is possible to perform optimal sound control.

In the example of FIG. 9, the vertical axis indicates a time integration value and the horizontal axis indicates the time, where the time integration value is 0 at any time.

Also, the first example to remove the above-mentioned scene change influence corresponds to processing in the scene structure change detecting unit 122 and the sound control depth information extracting unit 125 in FIG. 1. That is, in this case, the scene structure change detecting unit 122 and the sound control depth information extracting unit 125 correspond to the time differentiator 162 and the non-linear converter 163. Also, the sound control signal generating unit 126 corresponds to the time integrator 164.

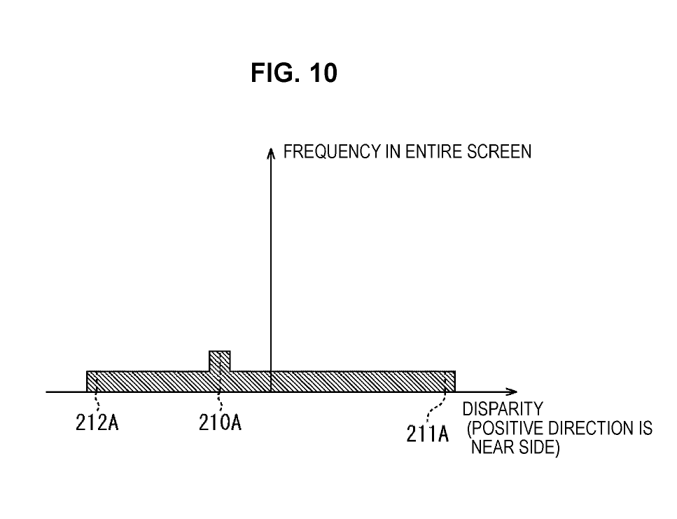

FIG. 10 is a view illustrating frequency distribution example of disparity in a case where an image contrast is low, as a second example. In the example of FIG. 10, a disparity mode value 210A, a disparity maximum value 211A and a disparity minimum value 212A are illustrated in the frequency distribution in which the horizontal axis indicates disparity (the positive direction is the near side) and the vertical axis indicates frequency in the entire screen.

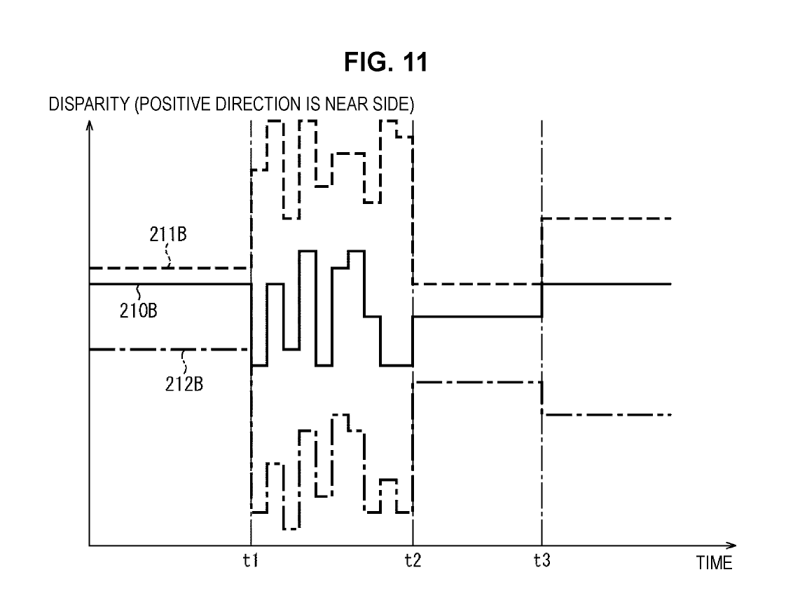

Also, FIG. 11 is a view illustrating a time change example of a disparity mode value 210B, disparity maximum value 211B and disparity minimum value 212B in this case. The vertical axis indicates disparity (the positive direction is the near side) and the horizontal axis indicates the time.

In the examples of FIG. 10 and FIG. 11, there is provided a scene example of low image contrast between time t1 and time t2. According to stereo matching characteristics, in a scene of low contrast, as illustrated in FIG. 10, the frequency distribution becomes flat, a difference between the disparity maximum value 211A and the disparity minimum value 212A becomes large and therefore it becomes difficult to accurately find disparity frequency distribution.

Also, as illustrated in a time period between time t1 and time t2 in FIG. 11, the time change in the disparity mode value 210B becomes unstable.

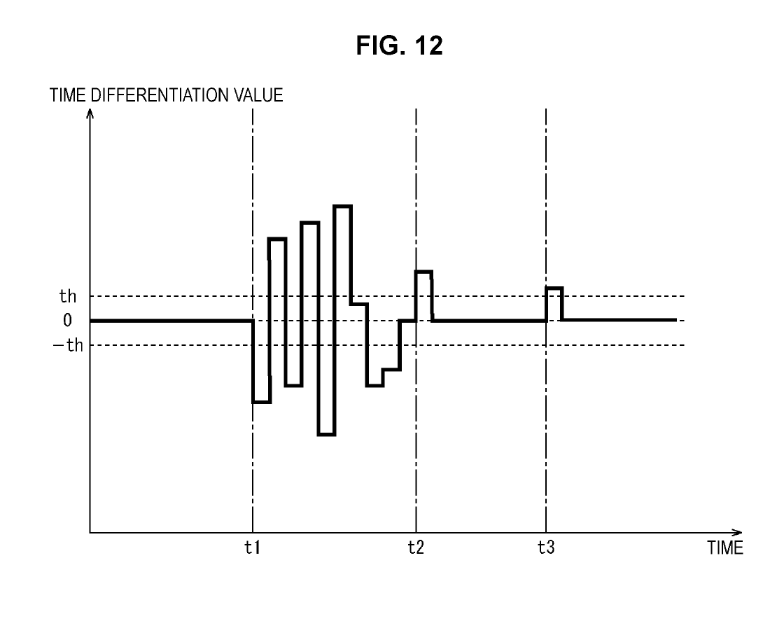

When this disparity mode value 210B is subjected to time differentiation by the time differentiator 162, for example, a signal as illustrated in FIG. 12 is acquired. The vertical axis indicates a time differentiation value and the horizontal axis indicates the time.

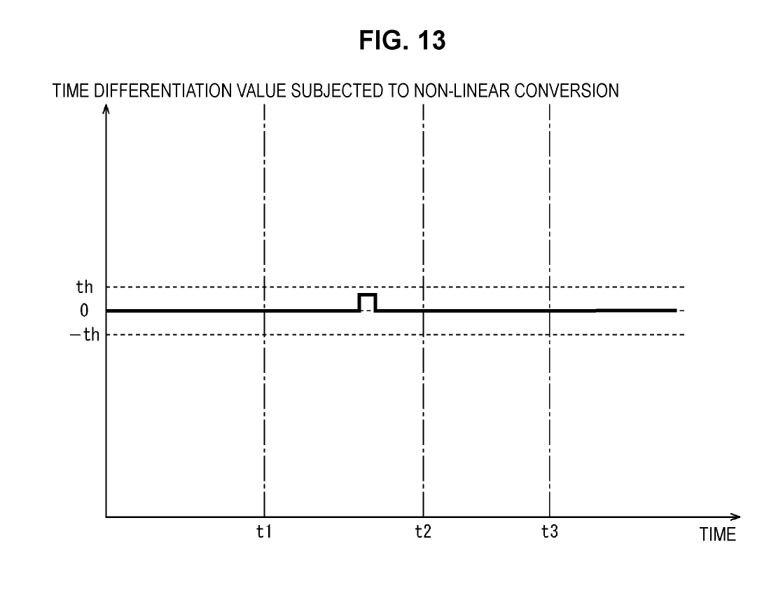

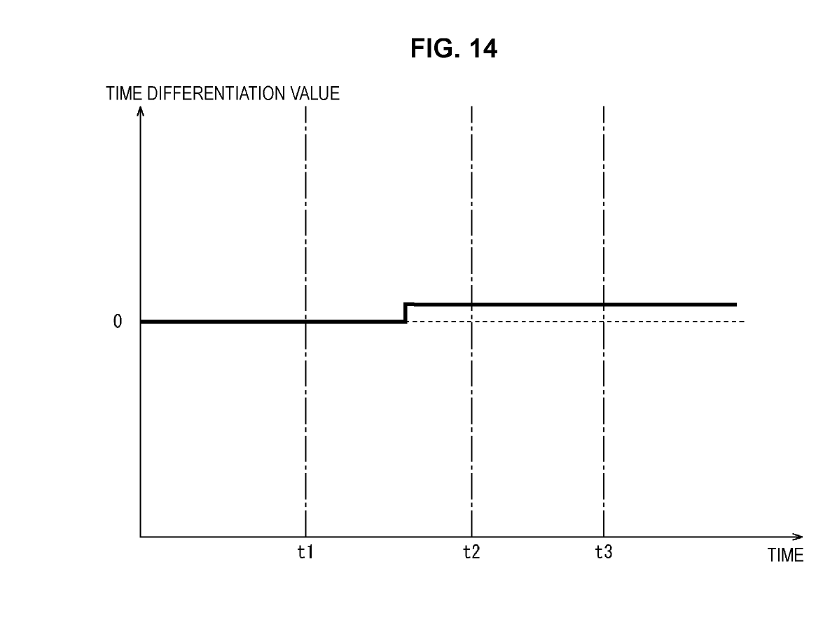

Generally, in a scene of low image contrast, by the above-mentioned reasons, for example, as illustrated in FIG. 12, there are many cases where the absolute value of the disparity time differentiation value is much greater than the adequately-set threshold th. Therefore, in the non-linear converter 163, by performing non-linear conversion on the characteristic illustrated in above FIG. 5, as illustrated in FIG. 13, it is possible to substantially remove disparity instability in the case of low image contrast, from the time differentiation value of the disparity mode value.

In the example of FIG. 13, the vertical axis indicates a time differentiation value subjected to non-linear conversion and the horizontal axis indicates the time, where the time differentiation value subjected to non-linear conversion indicates a value (>0) equal to or below th at the time period between time t1 and time t2, and indicates 0 in other time periods.

Also, this time differentiation value of disparity mode value subjected to non-linear conversion is subjected to time integration in the time integrator 164. By this means, it is possible to acquire a disparity mode value from which a disparity instability influence is substantially removed in the case of low disparity reliability such as the case of a scene of low image contrast as illustrated in FIG. 14. Further, in this case, by initializing the time integrator 164 using at least one index out of the indices Q and T, it is possible to remove the disparity instability in the case of low image contrast more accurately. Also, details of the indices are described below.

In the example of FIG. 14, the vertical axis indicates a time integration value and the horizontal axis indicates the time, where the time integration value indicates 0 before a certain time between time t1 and time t2 and indicates a certain value (>0) after the certain time.

Here, the above-mentioned second example in the case of low disparity reliability such as the case of low image contrast corresponds to processing in the depth information reliability deciding unit 123 and the sound control depth information extracting unit 125 in FIG. 1. That is, in this case, the depth information reliability deciding unit 123 and the sound control depth information extracting unit 125 correspond to the time differentiator 162 and the non-linear converter 163. Further, the sound control signal generating unit 126 corresponds to the time integrator 164.

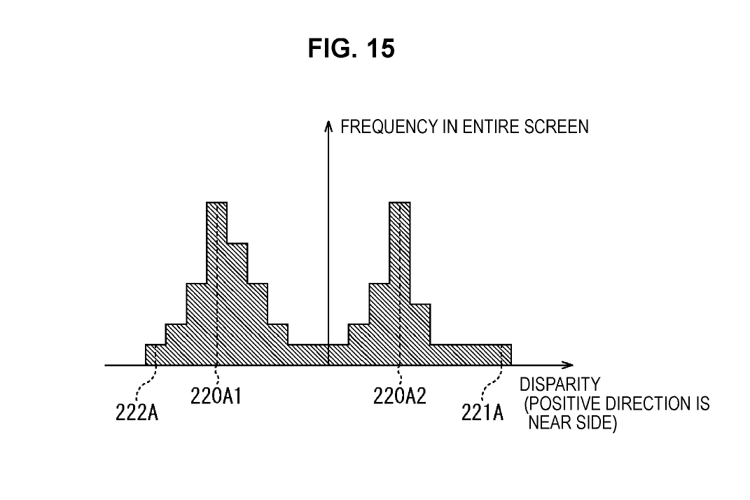

FIG. 15 is a view illustrating a frequency distribution of disparity in a case where the area ratios of two objects to the entire screen are substantially equal, as a third example. In the example of FIG. 15, disparity mode values 220A1 and 220A2, a disparity maximum value 221A and a disparity minimum value 222A are illustrated in the frequency distribution in which the horizontal axis indicates disparity (the positive direction is the near side) and the vertical axis indicates frequency in the entire screen.

In such a case, since it is often difficult to decide which of two objects is significant according to their area relationship, it has a low reliability as disparity information used to generate a sound control signal.

Generally, such two objects often have a large difference in depth like “character” and “background,” and therefore there are many cases where a difference between two disparity mode value 220A1 and disparity mode value 220A2 has a large value.

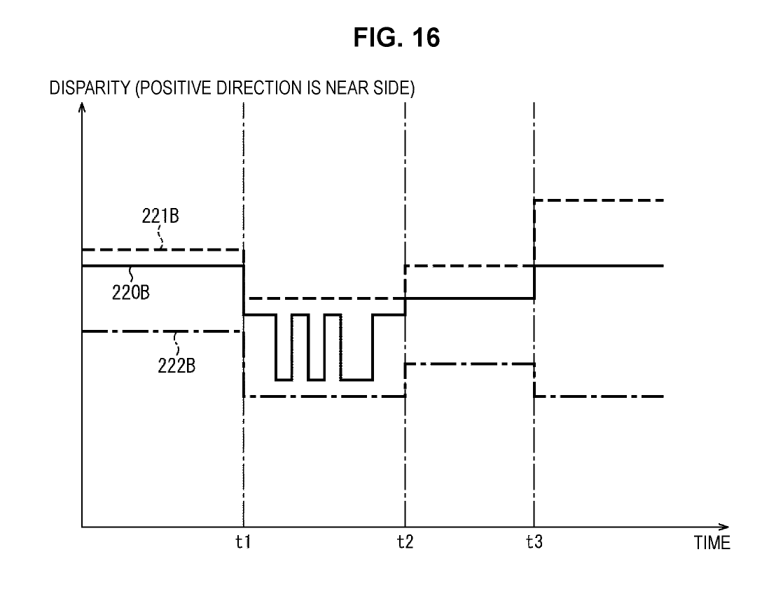

FIG. 16 is a view illustrating a time change example of a disparity mode value 220B, disparity maximum value 221B and disparity minimum value 222B in this case. The vertical axis indicates disparity (the positive direction is the near side) and the horizontal axis indicates the time.

In this example, the area ratios of two objects to the entire screen are substantially equal between time t1 and time t2, and, by adding an influence of noise or detection error, the disparity mode value 220B has two disparity values in a random manner.

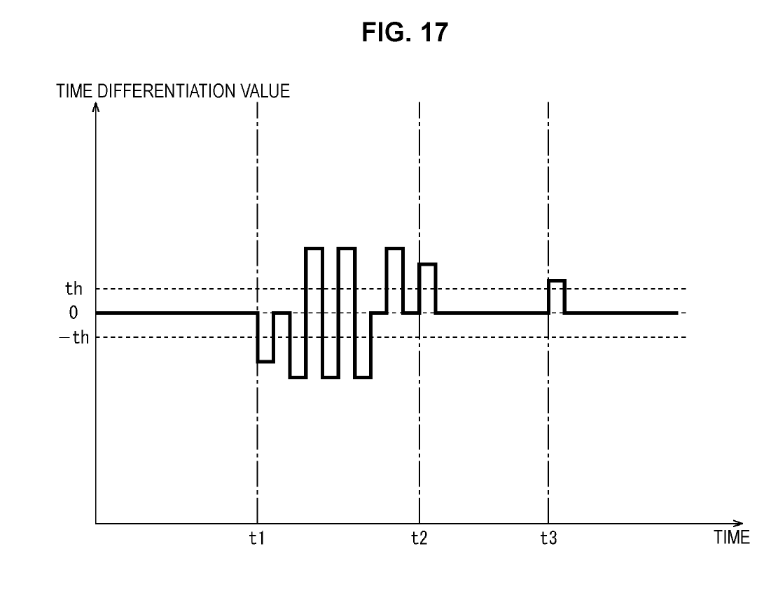

When this disparity mode value 220B is subjected to time differentiation in the time differentiator 162, for example, a signal as illustrated in FIG. 17 is acquired. The vertical axis indicates a time differentiation value and the horizontal axis indicates the time.

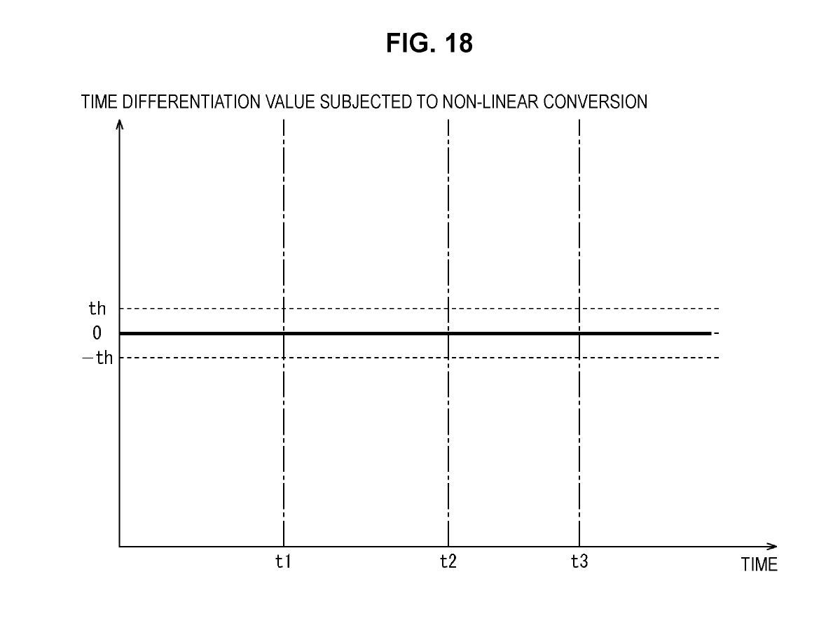

As described above, since there are many cases where a disparity difference between two objects is large, the absolute value of the disparity time differentiation value often has a larger value than an adequately-set threshold th. Therefore, by performing non-linear conversion on the characteristic illustrated in above FIG. 5 in the non-linear converter 163, as illustrated in FIG. 18, it is possible to substantially remove, from the time differentiation value of the disparity mode value, a disparity instability in a case where the ratios of two objects to the entire screen are substantially equal.

In the example of FIG. 18, the vertical axis indicates a time differentiation value subjected to non-linear conversion and the horizontal axis indicates the time, where the time differentiation value subjected to non-linear conversion indicates 0 at any time.

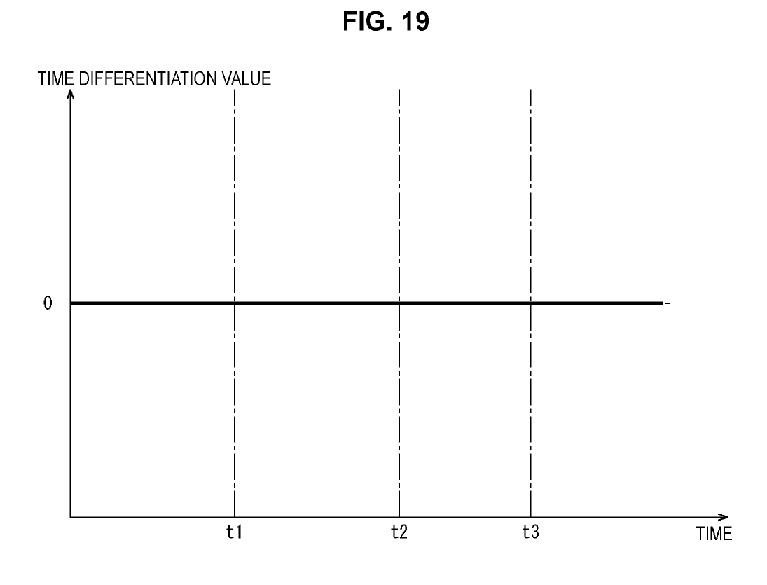

Also, this time differentiation value of disparity mode value subjected to non-linear conversion is subjected to time integration in the time integrator 164. By this means, it is possible to acquire a disparity mode value from which a disparity instability influence is substantially removed in a case where the ratios of two objects to the entire screen are substantially equal as illustrated in FIG. 19.

In the example of FIG. 19, the vertical axis indicates a time integration value and the horizontal axis indicates the time, where the time integration value is 0 at any time.

Also, similar to the above second example, the third example in the case of low disparity reliability, such as a case where the above-mentioned ratios of two objects to the entire screen are substantially equal, corresponds to processing in the depth information reliability deciding unit 123 and the sound control depth information extracting unit 125 in FIG. 1. That is, in this case, the depth information reliability deciding unit 123 and the sound control depth information extracting unit 125 correspond to the time differentiator 162 and the non-linear converter 163. Further, the sound control signal generating unit 126 corresponds to the time integrator 164.

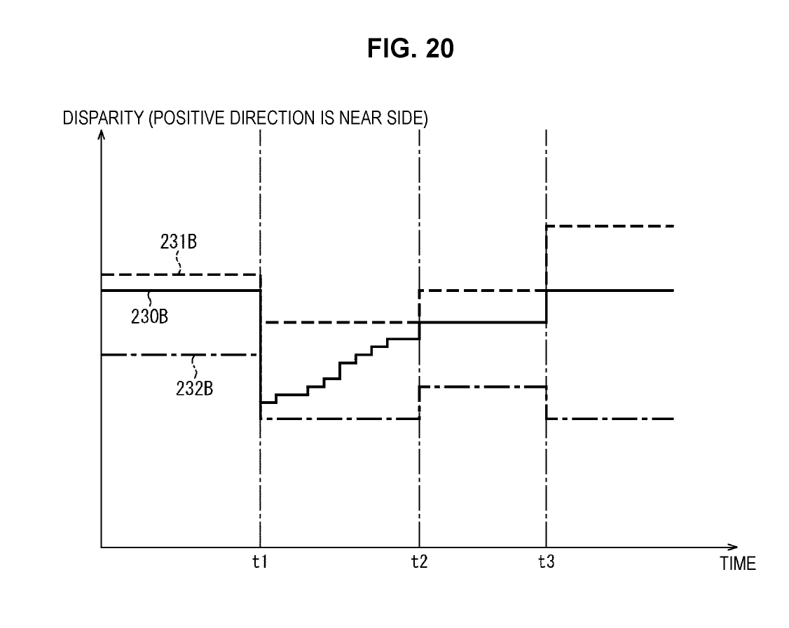

FIG. 20 is a view illustrating a time change in a disparity mode value 230B, disparity maximum value 231B and disparity minimum value 232B in a scene in which a main subject moves from the far side to the near side. The vertical axis indicates disparity (the positive direction is the near side) and the horizontal axis indicates the time.

In the example of FIG. 20, a main object moves from the far side to the near side between time t1 and time t2, thereby changing in a direction in which the disparity mode value 230B gradually becomes large.

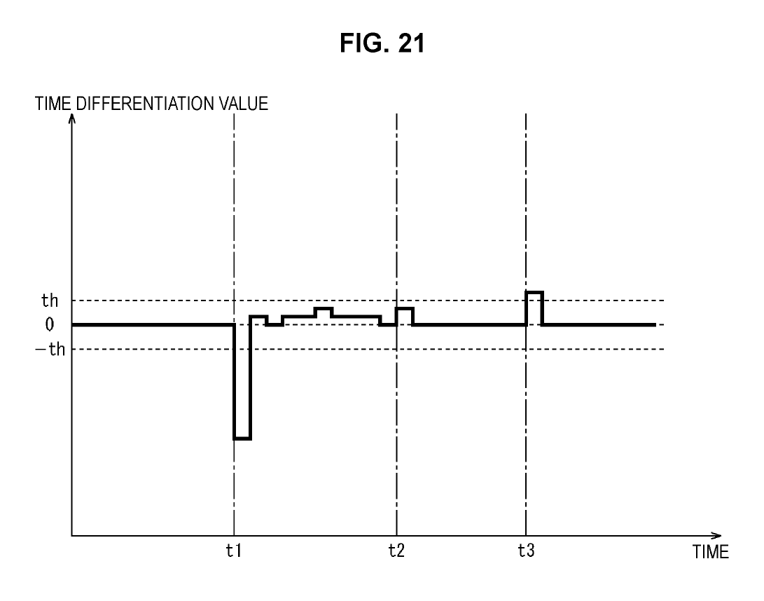

When this disparity mode value 230B is subjected to time differentiation in the time differentiator 162, for example, a signal as illustrated in FIG. 21 is acquired. The vertical axis indicates a time differentiation value and the horizontal axis indicates the time.

Between time t1 and time t2 in the example of FIG. 21, the absolute value of disparity time differentiation value equal to or above th occurs at time t1, and, after that, the absolute value of disparity time differentiation value having a smaller value (>0) than th occurs many times.

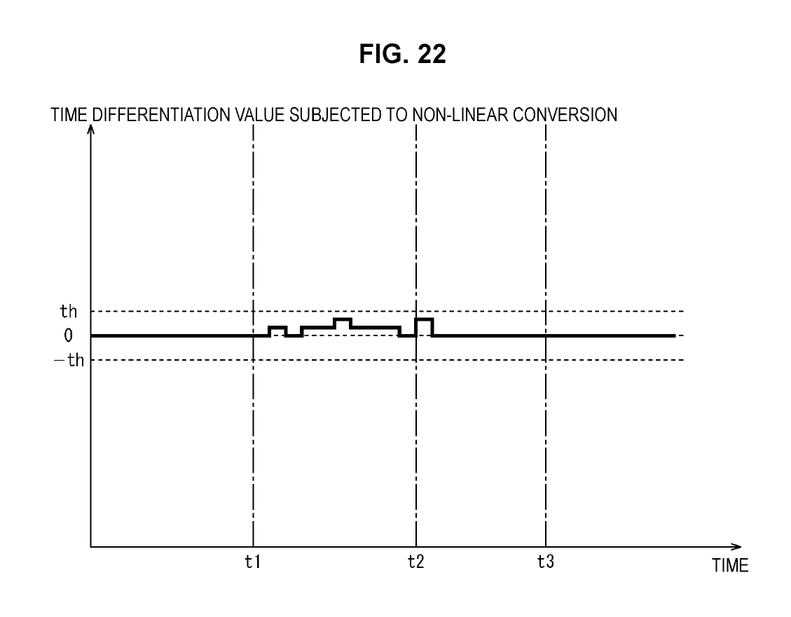

The anteroposterior movement of the main subject differs from that in the above-mentioned first to third examples, and there are many cases where the absolute value of the disparity time differentiation value has a smaller value (>0) than the above threshold th that is adequately set. Therefore, by performing non-linear conversion on the characteristic illustrated in above FIG. 5 in the non-linear converter 163, as illustrated in FIG. 22, it is possible to perform reflection to the time differentiation value subjected to non-linear conversion.

In the example of FIG. 22, the vertical axis indicates a time differentiation value subjected to non-linear conversion and the horizontal axis indicates the time, where the time differentiation value subjected to non-linear conversion indicates a smaller value (>0) than th at time between t1 and t2.

Also, by adequately setting this threshold th, it is possible to remove a case where it is difficult to follow sound control, such as a depth change with fast time change, and therefore it is possible to avoid that unnaturalness is caused in the sound control.

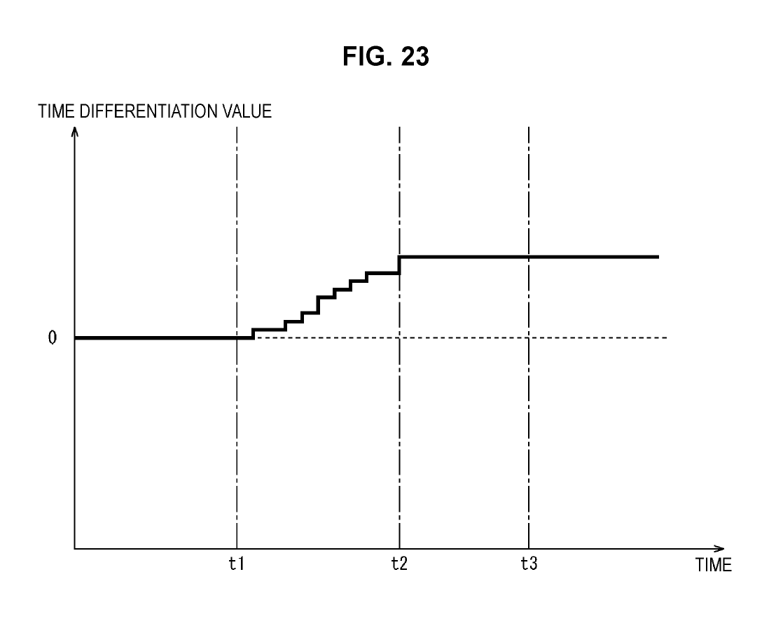

Also, by performing time integration on this time differentiation value of disparity mode value subjected to non-linear conversion in the time integrator 164, as illustrated in FIG. 23, it is possible to acquire a disparity mode value in a scene in which the main subject moves from the far side to the near side.

In the example of FIG. 23, the vertical axis indicates a time integration value and the horizontal axis indicates the time, where the time integration value indicates 0 before time t1 and indicates a gradually larger value (>0) at the time between time t1 and time t2.

Also, the above-mentioned fourth example corresponds to processing in the acoustic control effect evaluating unit 124 and the sound control depth information extracting unit 125 in FIG. 1. That is, in this case, the acoustic control effect evaluating unit 124 and the sound control depth information extracting unit 125 correspond to the time differentiator 162 and the non-linear converter 163. Further, the sound control signal generating unit 126 corresponds to the time integrator 164.

As described above, by adequately setting the threshold th in the non-linear conversion characteristic, it is possible to remove an influence in the above-mentioned first to third cases. Also, as in the fourth case, it is possible to reflect only the main subject corresponding to a depth direction operation acquired as a result of optimal control, to a time differentiation value.

As described above, these first to third cases correspond to cases where: a scene change occurs; image contrast is low and the disparity reliability is low; and there are multiple objects in which it is difficult to decide a main object.

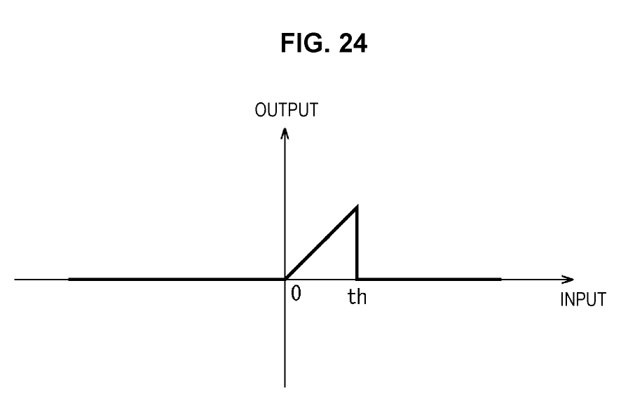

Also, in the above explanation, although an example using the non-linear conversion characteristic in FIG. 5 has been explained, a non-linear conversion characteristic illustrated in FIG. 24 may be used instead.

In the example of FIG. 24, a non-linear conversion characteristic to make an output “0” is illustrated with respect to an input of other values than values between 0 and the threshold th. By using such a characteristic, in a case where the disparity changes in a reduction direction, the time differentiation value of disparity mode value subjected to non-linear conversion as an output from the non-linear converter 163 becomes 0 and a sound control signal from the time integrator 164 becomes 0 when the main subject moves to the far side. That is, it is possible to perform control to limit a cooperation direction of sound control with respect to disparity, to a direction in which a 3D image is pulled out.

As described above, by arbitrarily setting a non-linear conversion characteristic, it is possible to change a characteristic of a sound control signal generated in response to a movement of a main subject.

### [Calculation Example of Indices P to S]

Next, referring to FIG. 3 again, processing in the index calculation processing unit 153 is specifically explained in order of indices P to T.

First, as a first index, an index P input from the subtracting unit 172 in the initialization deciding unit 154 is explained. By the subtracting unit 172, a value subtracting a time average value of mode value from a disparity mode value from the disparity mode value detecting unit 161 is output to the initialization deciding unit 154 as the index P.

This time average value of mode value indicates a depth standard position at the time of creating a 3D image, which is often set to an actual screen or in a slightly deeper side. In a case where the mode value is a value close to the above value, it follows that a creator of the 3D image sets a main object to the standard depth, and there is a high possibility that a pull-out effect or pull-in effect in a 3D image is not intended. Therefore, in a case where the index P (i.e. a value subtracting an average value from a mode value calculated by the subtracting unit 172) has a value close to 0, it can become an index to initialize the time integrator 164 and set a sound control signal to 0.

Next, as a second index, an index Q input from the subtracting unit 175 in the initialization deciding unit 154 is explained.

By the subtracting unit 175, a difference between the disparity minimum value from the disparity minimum value detecting unit 173 and a disparity maximum value from the disparity maximum value detecting unit 174 is output to the initialization deciding unit 154 as the index Q.

As the difference value between the disparity minimum value and the disparity maximum value is larger, it shows that an anteroposterior width of a scene depth structure is wider. In a normal 3D image, by maintaining this difference value within a certain range, although there is provided an image in which the entire screen is fusional, in a case where a disparity detection result is not correctly found in an image in which stereo matching is difficult, it has an abnormally large value.

Therefore, since there is a high possibility that the disparity is not accurately found in a case where the difference value is equal to or above a certain value, when the index Q (i.e. difference between the maximum value and the minimum value) has an abnormally large value, it can become an index to initialize the time integrator 164 and set a sound control signal to 0.

Further, as a third index, an explanation is given to the index R input from the time differentiator 176 in the initialization deciding unit 154 and the index S input from the time differentiator 177 in the initialization deciding unit 154.

The disparity minimum value detected by the disparity minimum value detecting unit 173 and the disparity maximum value detected by the disparity maximum value detecting unit 174 are subjected to time differentiation in the time differentiator 176 and the time differentiator 177, and a time differentiation value of the minimum value and a time differentiation value of the maximum value are found.

As described above with reference to FIG. 11 and FIG. 12, in a case where the time differentiation value of the minimum value and the time differentiation value of the maximum value have a larger value than the threshold th, there is a high possibility that image contrast is low and a disparity detection result by stereo matching processing is difficult. Therefore, the time differentiation value of the minimum value and the time differentiation value of the maximum value can be indices to initialize the time integrator 164 and set a sound control signal to 0.

Finally, as a fourth index, the index T input from the time differentiator 162 in the initialization deciding unit 154 is explained.

As described above, by operations in the time differentiator 162 and the non-linear converter 163, in cases where: a scene change influence from disparity is small and image contrast is low; and the ratios of multiple objects to the entire screen are substantially equal, it is possible to remove an influence of disparity instability.

At the same time, by initializing the time integrator 164, a scene is detected in which the next main subject moves in the depth direction, and, since the initial value of a sound control signal is set to 0 when it is shifted to a scene in which time integration restarts, it is possible to perform adequate sound control.

Therefore, in a case where the absolute value of a differentiation value from the time differentiator 162 is over the threshold th, a lower limit threshold thL or upper limit threshold thH that is separately set in an arbitrary manner, it can become an index to initialize the time integrator 164 and set a sound control signal to 0.

Using these four types of five indices P to T, the initialization deciding unit 154 decides whether to initialize the time integrator 164, and, when it is decided to perform initialization, an initialization signal is generated and output to the time integrator 164.

In the present embodiment, since the time differentiation value of disparity is used, there occurs a delay of at least one image frame between the time when disparity information is input from the stereo matching unit 151 as depth information and the time when a sound control signal is output from the time integrator 164.

It is needless to say that, if a delay of one image frame or more is allowed on the system, by performing adequate noise removal filter processing on the disparity information acquired by stereo matching, it may be possible to mitigate a detection difference in the stereo matching. The adequate noise removal filter denotes, for example, a moving average filter or median filter.

Here, four types of five indices P to T are used as an index input in the initialization deciding unit 154, but, in addition to these, switching information of broadcast channels or input sources and external information such as a scene change detection using an image inter-frame difference may be used.

Also, in the above explanation, an example has been described where disparity frequency distribution is found from a left eye image and right eye image by stereo matching processing to use a disparity mode value, disparity maximum value and disparity minimum value, but it is not limited to this. For example, it is needless to say that, in a case where information to enable conversion into the mode value, maximum value and minimum value of disparity is attached to an image, it can be used.

### [Processing in Sound Controlling Unit]

Next, an explanation is given to processing of controlling a sound signal using a sound control signal generated as above.

In the case of controlling sound, as a main control target, for example, a center channel is the most suitable in a 5.1ch sound signal. This is because, since performer's line is often assigned to the center channel and further a sound effect produced by a subject imaged as an image in a screen is assigned to the center channel too, it is easily linked to depth information detected from the image.

Also, as an acoustic parameter that can control a sound distance sense, there are provided a sound volume, a frequency characteristic, a relative sound volume of initial reflection sound with respect to direct sound and a delay time (see Osamu Komiyama, Acoustic regeneration system for stereoscopic vision, The Acoustical Society of Japan, volume 66, number 12 (2010), pp. 610-615).

Therefore, in the following, an explanation is given to a method of controlling the above acoustic parameter of the center channel using the generated sound control signal. Here, in the generated sound control signal, although the disparity is basic information, since an unrequested element for sound control is removed, relevance with the image depth is lost.

Also, for ease of explanation, a disparity value (whose unit is one pixel) in a specific view condition is used as a unit of a sound control signal. For example, it is controlled such that: sound is perceived on a display screen (i.e. actual screen) when the sound control signal is 0; sound is perceived on the pull-out direction when the sound control signal has a positive value; and sound is perceived on the pull-in direction when the sound control signal has a negative value.

### [Configuration Example of Sound Controlling Unit]

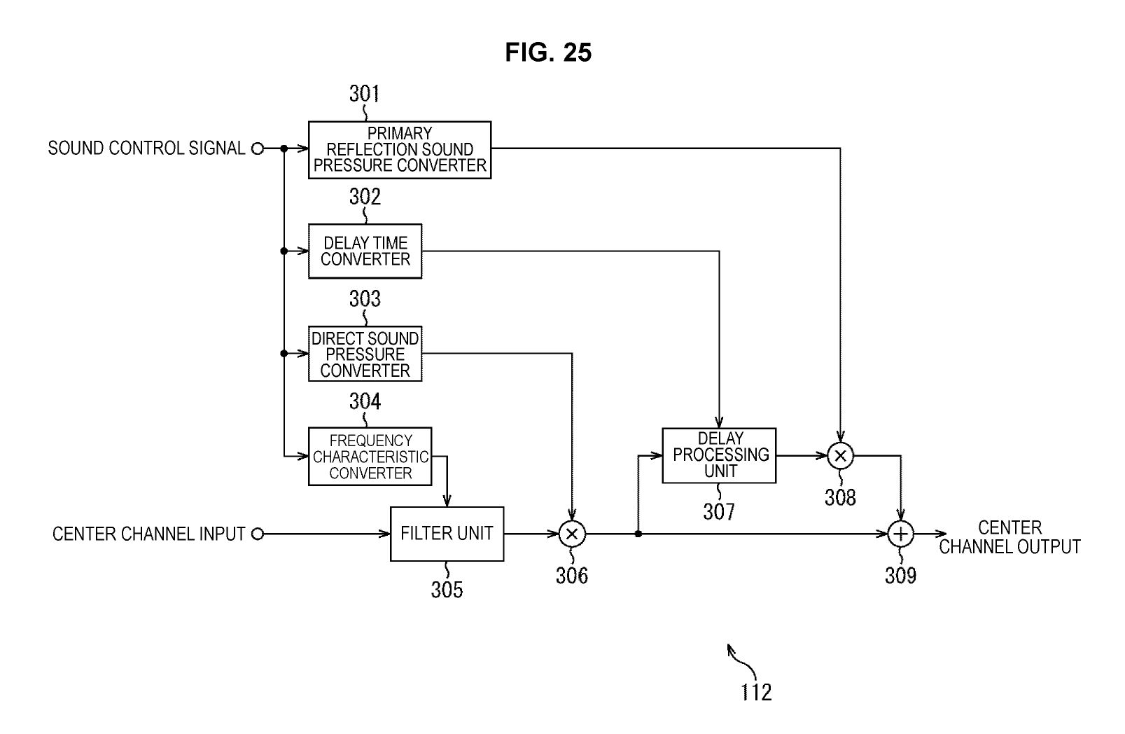

FIG. 25 is a view illustrating a configuration example of a sound controlling unit.

The sound controlling unit 112 is formed including, for example, a primary reflection sound pressure converter 301, a delay time converter 302, a direct sound pressure converter 303, a frequency characteristic converter 304, a filter unit 305, a multiplier 306, a delay processing unit 307, a multiplier 308 and an adder 309.

A sound control signal from the time integrator 114 is input in the primary reflection sound pressure converter 301, the delay time converter 302, the direct sound pressure converter 303 and the frequency characteristic converter 304. This sound control signal is a disparity mode value optimized as above.

The frequency characteristic converter 304 converts the sound control signal from the time integrator 114 into a frequency characteristic parameter and outputs the converted frequency characteristic parameter to the filter unit 305.

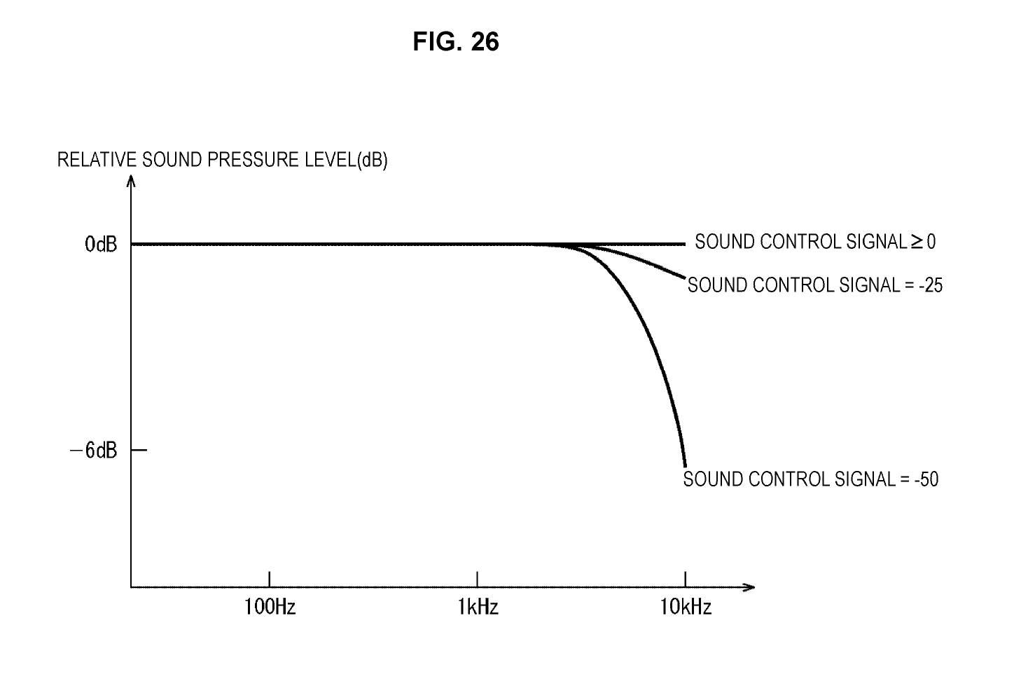

As an example, the frequency characteristic has a characteristic illustrated in FIG. 26, which reproduces a phenomenon that, when the sound control signal (i.e. disparity value) becomes smaller, in other words, when the sound source distance becomes wider, attenuation of high frequency due to air absorption becomes large.

The filter unit 305 performs filter processing on a center channel input from the previous stage and outputs a signal subjected to filter processing to the multiplier 306.

Here, with respect to the center channel input, by changing a coefficient of the filter unit 305 by a frequency parameter, the distance sense is controlled.

The direct sound pressure converter 303 converts the sound control signal from the time integrator 114 into the sound pressure gain of the direct sound and outputs the converted sound pressure gain of the direct sound to the multiplier 306.

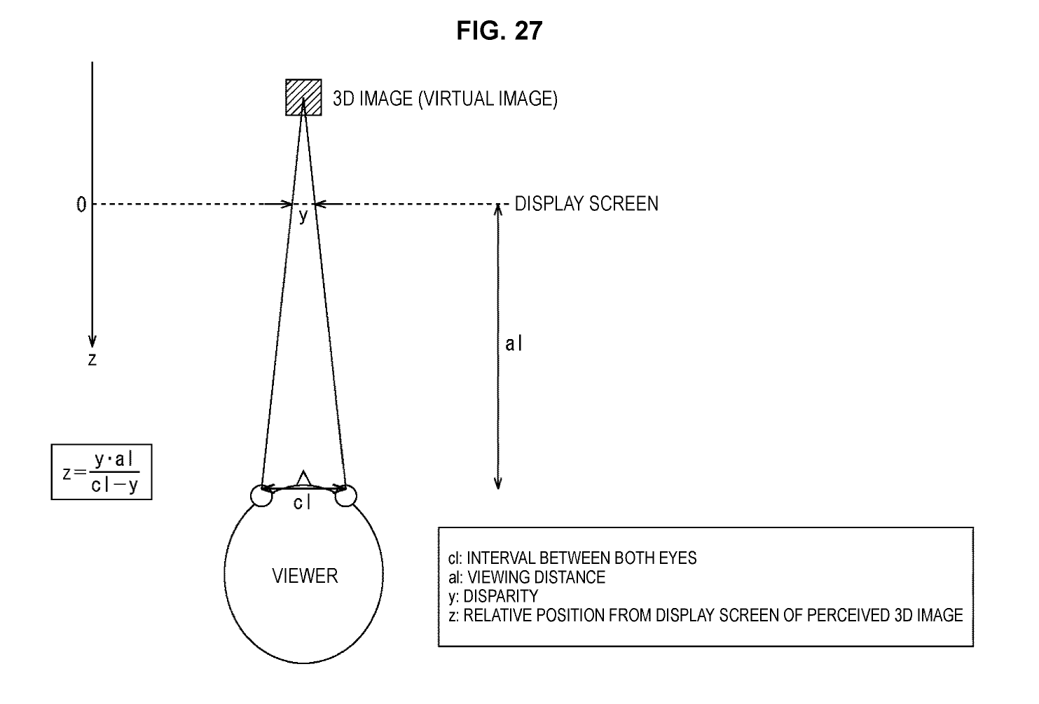

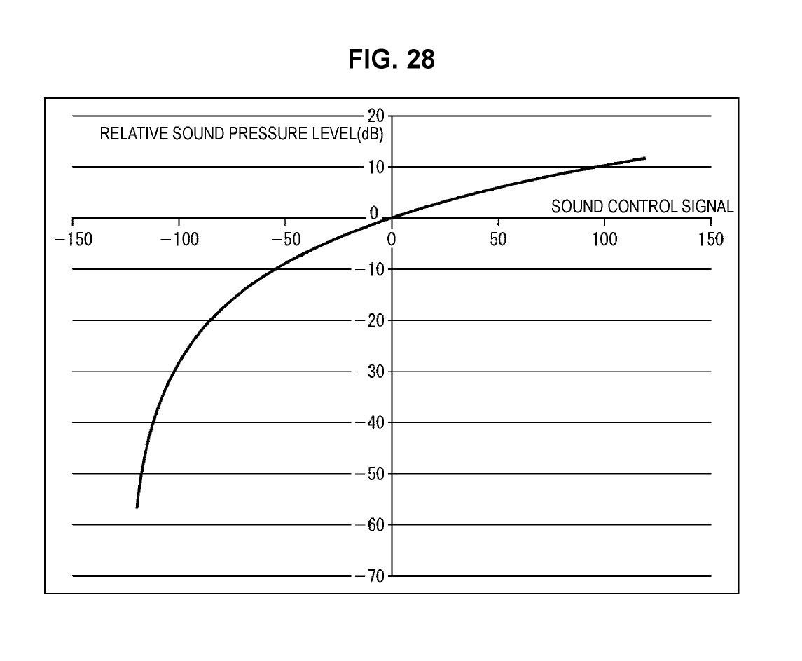

As an example of the sound pressure gain of the direct sound, like a pattern diagram illustrated in FIG. 27, regarding a depth z to perceive a 3D image with respect to disparity y, a value calculated as a relative value with respect to the value of z in the case of the disparity y of 0 is used, thereby providing a characteristic as illustrated in FIG. 28. Naturally, this is an example and it is possible to arbitrarily set a characteristic of the sound pressure gain such that an adequate effect is acquired.

The multiplier 306 controls the distance sense by multiplying the signal subjected to filtering in the filter unit 305 by the sound pressure gain from the direct sound pressure converter 303. The signal from the multiplier 306 is output to the delay processing unit 307 and the adder 309.

The delay time converter 302 converts the sound control signal from the time integrator 114 into delay time of primary reflection sound and outputs the converted delay time of primary reflection sound to the delay processing unit 307.

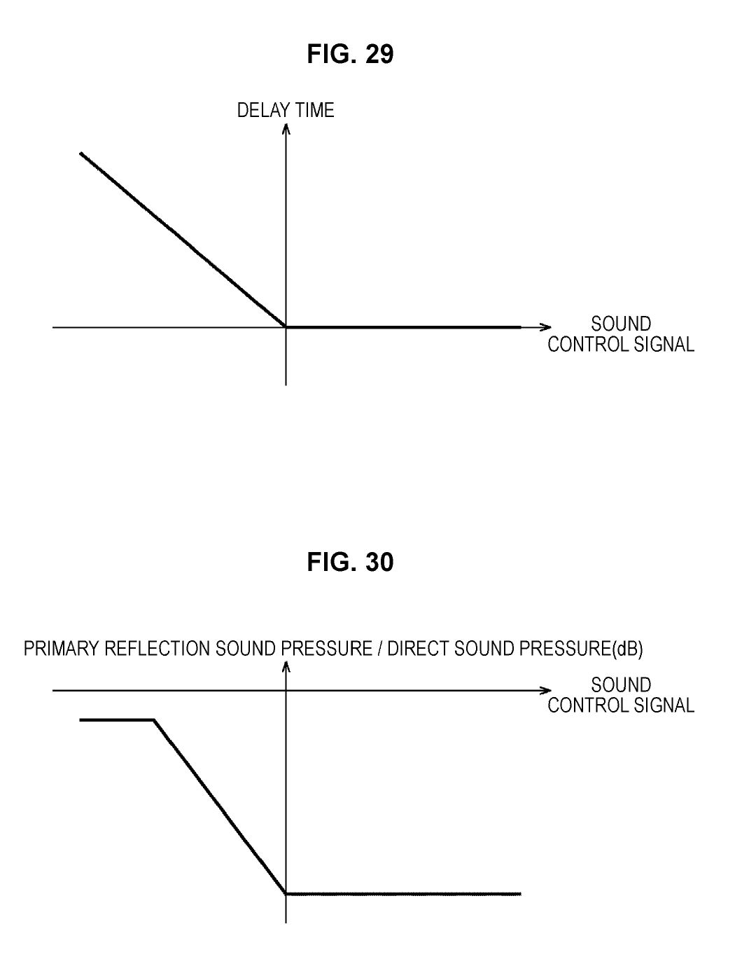

As an example, the delay time of primary reflection sound has a characteristic as illustrated in FIG. 29. Although this characteristic is based on a time delay of single reflection sound and one acknowledgement of a perceived sound image distance, this is an example and an arbitrary characteristic may be set (see T. Gotoh, Y, Kimura, A. Kurahashi and A. Yamada: A consideration of distance perception in binaural hearing J. Acoustic Society Japan (E), 33, pp 667-671).

The delay processing unit 307 performs delay processing on the signal from the multiplier 306 using the delay time of primary reflection sound converted by the delay time converter 302, and outputs the signal subjected to delay processing to the multiplier 308.

The primary reflection sound pressure converter 301 converts the sound control signal from the time integrator 114 into a sound pressure ratio of the primary reflection sound to the direct sound, and outputs, to the multiplier 308, the converted sound pressure ratio of the primary reflection sound to the direct sound.

FIG. 30 is a view illustrating an example of a sound pressure ratio characteristic of primary reflection sound. This is also an example and the characteristic may be arbitrarily set.

The multiplier 308 multiplies the signal subjected to delay processing from the delay processing unit 307 by the sound pressure ratio of the primary reflection sound to the direct sound, and outputs the multiplication result to the adder 309.

The adder 309 adds the signal, which is multiplied by the sound pressure ratio of the primary reflection value to the direct sound, to the signal from the multiplier 306 for which the distance sense is controlled and the signal subjected to delay processing in the multiplier 308, and outputs the addition result to, for example, an unillustrated speaker in a subsequent stage as a center channel output.

As described above, according to the present disclosure, it is possible to suppress the mismatch between an image distance sense and sound distance sense in a 3D product by adjusting a sound depth sense using depth information of a 3D image.

At this time, by deletion of the following information unsuitable for cooperation of image and sound and by low processing delay time, it is possible to acquire a good cooperation effect of image and sound without increasing the cost of an image delay memory.

The information unsuitable for cooperation, that is, a depth structure change by a scene change or the like, an unstable behavior of stereo matching and an erroneous decision of a main object in a scene formed with objects having multiple kinds of depth information are removed, which are included in depth information.

Incidentally, the above mentioned series of processes can be executed by hardware, or can be executed by software. In the case where the series of processes is executed by software, a program configuring this software is installed in a computer. Here, a computer incorporated into specialized hardware, and a general-purpose personal computer, which is capable of executing various functions by installing various programs, are included in the computer.

### 2. Second Embodiment

### Configuration Example of Computer

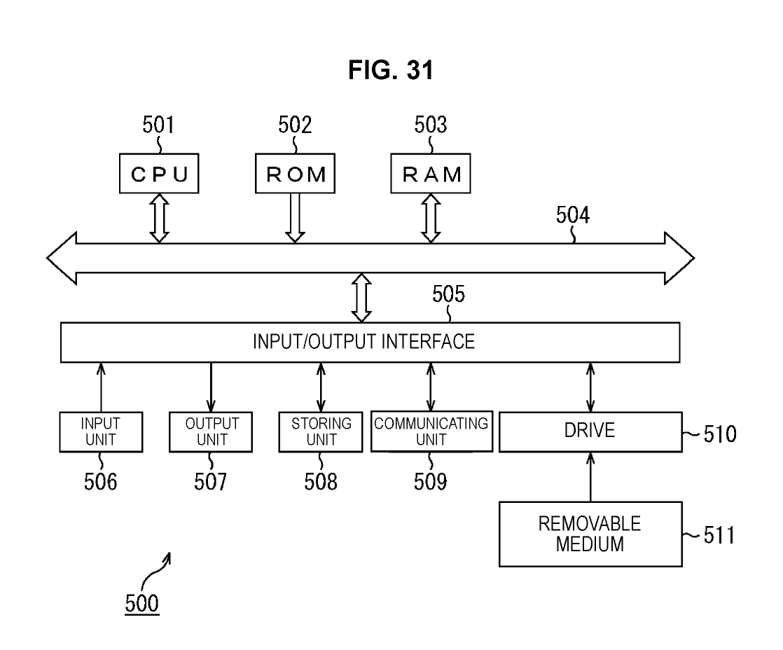

FIG. 31 illustrates a configuration example of hardware of a computer that executes the above series of processes by programs.

In the computer 500, a CPU (Central Processing Unit) 501, a ROM (Read Only Memory) 502 and a RAM (Random Access Memory) 503 are connected to each other via a bus 504.

The bus 504 is further connected to an input/output interface 505. The input/output interface 505 is connected to an input unit 506, an output unit 507, a storing unit 508, a communicating unit 509 and a drive 510.

The input unit 506 includes a keyboard, a mouse and a microphone, and so on. The output unit 507 includes a display and a speaker, and so on. The storing unit 508 includes a hard disk and a nonvolatile memory, and so on. The communicating unit 509 includes a network interface and so on. The drive 510 drives removable medium 511 such as a magnetic disk, an optical disk, a magnetic-optical disk and a semiconductor memory.

In the computer configured as above, for example, the CPU 501 loads the programs stored in the storing unit 508 onto the RAM 503 via the input/output interface 505 and the bus 504 and executes the programs, thereby performing the above series of processes.

The programs executed by the computer (i.e. CPU 501) can be recorded in the removable medium 511 such as a package medium and provided. Also, the programs can be provided via a wired or wireless transmission medium such as a local area network, the Internet and digital satellite broadcasting.

In the computer, by attaching the removable medium 511 to the drive 510, it is possible to install the programs in the storing unit 508 via the input/output interface 505. Also, it is possible to receive the programs in the communicating unit 509 via the wired or wireless transmission medium and install them in the storing unit 508. In addition, it is possible to install the programs in advance in the ROM 502 or the storing unit 508.

Programs executed by a computer may be performed in time-series according to the description order of the present disclosure, or may be performed in parallel or at necessary timings when called.

In the present disclosure, steps of describing the above series of processes may include processing performed in time-series according to the description order and processing not processed in time-series but performed in parallel or individually.

Embodiments of the present disclosure are not limited to the above-described embodiments and can be variously modified within the gist of the present disclosure.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Also, the configuration described above as one device (or processing unit) may be divided into a plurality of devices (or processing units). On the other hand, the configuration described above as a plurality of devices (or processing units) may be integrated into one device. Also, other components may be added to the configuration of each device (or each processing unit). As long as the configuration or operation of the system is substantially similar as a whole, a part of the configuration of any device (or processing unit) may also be allowed to be included in other devices (or other processing units). The present technology is not limited to the above-mentioned embodiments, but can be variously modified within the scope of the present disclosure.

Although preferred embodiments of the present disclosure have been described above in detail with reference to the accompanying drawings, the disclosure is not limited to these examples. It is clear that those skilled in the art having normal knowledge in the field to which the present disclosure belongs, can think of various modification examples and alternation examples within a range of the technical idea recited in the claims, and it is naturally understood that these belong to the technical field of the present disclosure.

Additionally, the present technology may also be configured as below.
(1) A signal processing apparatus including:

a disparity mode value calculating unit calculating a mode value of disparity related to dynamic image information;

a time interval extracting unit extracting a time interval suitable for cooperation of perception of an anteroposterior sense from a change in a time direction of the mode value calculated by the disparity mode value calculating unit; and

a control signal generating unit generating a sound control signal to control a depth sense of sound information related to the dynamic image information in the time interval extracted by the time interval extracting unit.
(2) The signal processing apparatus according to (1), wherein the time interval extracting unit detects a change in a scene structure of the dynamic image information based on the dynamic image information and the mode value calculated by the disparity mode value calculating unit, and removes a time interval in which the change is detected.
(3) The signal processing apparatus according to (2),

wherein the scene structure change detecting unit includes a time differentiation unit performing time differentiation on the mode value calculated by the disparity mode value calculating unit, and a non-linear conversion unit performing non-linear conversion on the mode value subjected to time differentiation in the time differentiation unit, and

wherein the control signal generating unit includes a time integration unit performing time integration on the mode value subjected to non-linear conversion in the non-linear conversion unit.
(4) The signal processing apparatus according to (3), wherein the scene structure change detecting unit further includes an initialization deciding unit initializing the time integration performed by the time integration unit, according to magnitude of an absolute value of the mode value calculated by the disparity mode value calculating unit.
(5) The signal processing apparatus according to (1) or (2), wherein the time interval extracting unit includes a mode value reliability deciding unit evaluating a reliability of the mode value based on the dynamic image information and the mode value calculated by the disparity mode value calculating unit and removing a time interval in which the reliability of the mode value is low.
(6) The signal processing apparatus according to (5),

wherein the mode value reliability deciding unit includes a time differentiation unit performing time differentiation on the mode value calculated by the disparity mode value calculating unit, and a non-linear conversion unit performing non-linear conversion on the mode value subjected to time differentiation in the time differentiation unit, and

wherein the control signal generating unit includes a time integration unit performing time integration on the mode value subjected to non-linear conversion in the non-linear conversion unit.
(7) The signal processing apparatus according to (6), further including:

a disparity maximum value calculating unit calculating a maximum value of the disparity; and

a disparity minimum value calculating unit calculating a minimum value of the disparity,

wherein the mode value reliability deciding unit further includes an initialization deciding unit initializing the time integration performed by the time integration unit, according to at least one of magnitude of a difference between the maximum value calculated by the disparity maximum value calculating unit and the minimum value calculated by the disparity minimum value calculating unit, a time change in the maximum value and a time change in the minimum value.
(8) The signal processing apparatus according to (7), wherein the initialization deciding unit initializes the time integration performed by the time integration unit, according to the magnitude of an absolute value of the mode value calculated by the disparity mode value calculating unit.
(9) The signal processing apparatus according to (1), (2), or (5), wherein the time interval extracting unit includes a sound control effect evaluating unit evaluating, based on sound information related to the dynamic image information and the mode value calculated by the disparity mode value calculating unit, an effect in a case where the sound information is controlled by the dynamic image information, and changing the sound control signal.
(10) The signal processing apparatus according to (9),

wherein the sound control effect evaluating unit includes a time differentiation unit performing time differentiation on the mode value calculated by the disparity mode value calculating unit, and a non-linear conversion unit performing non-linear conversion on the mode value subjected to time differentiation in the time differentiation unit, and

wherein the control signal generating unit includes a time integration unit performing time integration on the mode value subjected to non-linear conversion in the non-linear conversion unit.
(11) The signal processing apparatus according to (10), wherein the sound control effect evaluating unit further includes an initialization deciding unit initializing the time integration performed by the time integration unit, according to a difference between the mode value calculated by the disparity mode value calculating unit and a time average value of the mode value.
(12) The signal processing apparatus according to (11), wherein the initialization deciding unit initializes the time integration performed by the time integration unit, according to magnitude of an absolute value of the mode value calculated by the disparity mode value calculating unit.
(13) A signal processing method in which a signal processing apparatus performs operations of:

calculating a mode value of disparity related to dynamic image information;

extracting a time interval suitable for cooperation of perception of an anteroposterior sense from a change in a time direction of the calculated mode value; and

generating a sound control signal to control a depth sense of sound information related to the dynamic image information in the extracted time interval.
(14) A program for causing a computer to function as:

a disparity mode value calculating unit calculating a mode value of disparity related to dynamic image information;

a time interval extracting unit extracting a time interval suitable for cooperation of perception of an anteroposterior sense from a change in a time direction of the mode value calculated by the disparity mode value calculating unit; and

a control signal generating unit generating a sound control signal to control a depth sense of sound information related to the dynamic image information in the time interval extracted by the time interval extracting unit.

The present disclosure contains subject matter related to that disclosed in Japanese Priority Patent Application JP 2012-117091 filed in the Japan Patent Office on May 23, 2012, the entire content of which is hereby incorporated by reference.

What is claimed is:

1. A signal processing apparatus comprising:
a disparity mode value calculating unit calculating a mode value of disparity related to dynamic image information;
a time interval extracting unit extracting a time interval suitable for cooperation of perception of an anteroposterior sense from a change in a time direction of the mode value calculated by the disparity mode value calculating unit; and
a control signal generating unit generating a sound control signal to control a depth sense of sound information related to the dynamic image information in the time interval extracted by the time interval extracting unit.

2. The signal processing apparatus according to claim 1, wherein the time interval extracting unit detects a change in a scene structure of the dynamic image information based on the dynamic image information and the mode value calculated by the disparity mode value calculating unit, and removes a time interval in which the change is detected.

3. The signal processing apparatus according to claim 2,
wherein the scene structure change detecting unit includes a time differentiation unit performing time differentiation on the mode value calculated by the disparity mode value calculating unit, and a non-linear conversion unit performing non-linear conversion on the mode value subjected to time differentiation in the time differentiation unit, and
wherein the control signal generating unit includes a time integration unit performing time integration on the mode value subjected to non-linear conversion in the non-linear conversion unit.

4. The signal processing apparatus according to claim 3, wherein the scene structure change detecting unit further includes an initialization deciding unit initializing the time integration performed by the time integration unit, according to magnitude of an absolute value of the mode value calculated by the disparity mode value calculating unit.

5. The signal processing apparatus according to claim 1, wherein the time interval extracting unit includes a mode value reliability deciding unit evaluating a reliability of the mode value based on the dynamic image information and the mode value calculated by the disparity mode value calculating unit and removing a time interval in which the reliability of the mode value is low.

6. The signal processing apparatus according to claim 5,
wherein the mode value reliability deciding unit includes a time differentiation unit performing time differentiation on the mode value calculated by the disparity mode value calculating unit, and a non-linear conversion unit performing non-linear conversion on the mode value subjected to time differentiation in the time differentiation unit, and
wherein the control signal generating unit includes a time integration unit performing time integration on the mode value subjected to non-linear conversion in the non-linear conversion unit.

7. The signal processing apparatus according to claim 6, further comprising:
a disparity maximum value calculating unit calculating a maximum value of the disparity; and
a disparity minimum value calculating unit calculating a minimum value of the disparity,
wherein the mode value reliability deciding unit further includes an initialization deciding unit initializing the time integration performed by the time integration unit, according to at least one of magnitude of a difference between the maximum value calculated by the disparity maximum value calculating unit and the minimum value calculated by the disparity minimum value calculating unit, a time change in the maximum value and a time change in the minimum value.

8. The signal processing apparatus according to claim 7, wherein the initialization deciding unit initializes the time integration performed by the time integration unit, according to the magnitude of an absolute value of the mode value calculated by the disparity mode value calculating unit.

9. The signal processing apparatus according to claim 1, wherein the time interval extracting unit includes a sound control effect evaluating unit evaluating, based on sound information related to the dynamic image information and the mode value calculated by the disparity mode value calculating unit, an effect in a case where the sound information is controlled by the dynamic image information, and changing the sound control signal.

10. The signal processing apparatus according to claim 9,
wherein the sound control effect evaluating unit includes a time differentiation unit performing time differentiation on the mode value calculated by the disparity mode value calculating unit, and a non-linear conversion unit performing non-linear conversion on the mode value subjected to time differentiation in the time differentiation unit, and
wherein the control signal generating unit includes a time integration unit performing time integration on the mode value subjected to non-linear conversion in the non-linear conversion unit.

11. The signal processing apparatus according to claim 10, wherein the sound control effect evaluating unit further includes an initialization deciding unit initializing the time integration performed by the time integration unit, according to a difference between the mode value calculated by the disparity mode value calculating unit and a time average value of the mode value.

12. The signal processing apparatus according to claim 11, wherein the initialization deciding unit initializes the time integration performed by the time integration unit, according to magnitude of an absolute value of the mode value calculated by the disparity mode value calculating unit.

13. A signal processing method in which a signal processing apparatus performs operations of:
calculating a mode value of disparity related to dynamic image information;
extracting a time interval suitable for cooperation of perception of an anteroposterior sense from a change in a time direction of the calculated mode value; and
generating a sound control signal to control a depth sense of sound information related to the dynamic image information in the extracted time interval.

14. A program for causing a computer to function as:
a disparity mode value calculating unit calculating a mode value of disparity related to dynamic image information;
a time interval extracting unit extracting a time interval suitable for cooperation of perception of an anteroposterior sense from a change in a time direction of the mode value calculated by the disparity mode value calculating unit; and
a control signal generating unit generating a sound control signal to control a depth sense of sound information related to the dynamic image information in the time interval extracted by the time interval extracting unit.

15. A signal processing apparatus comprising:
a disparity mode value calculating unit calculating a mode value of disparity related to dynamic image information;
a time differentiation unit performing time differentiation on the mode value calculated by the disparity mode value calculating unit;
a non-linear conversion unit performing non-linear conversion on the mode value subjected to time differentiation in the time differentiation unit; and
a time integration unit performing time integration on the mode value subjected to non-linear conversion in the non-linear conversion unit.
